(19) United States
(12) Patent Application Publication
(10) Pub. No.: US 2012/0141799 A1
(43) Pub. Date: Jun. 7, 2012

(54) Film on Graphene on a Substrate and Method and Devices Therefor

(76) Inventors: Francis Kub, Arnold, MD (US); Travis Anderson, Alexandria, VA (US); Michael Mastro, Fairfax, VA (US)

(21) Appl. No.: 13/310,347

(22) Filed: Dec. 2, 2011

Related U.S. Application Data
(60) Provisional application No. 61/419,267, filed on Dec. 3, 2010.

(51) Int. Cl. B32B 9/00; B82Y 30/00

(52) U.S. Cl. 428/408; 977/734

(57) ABSTRACT

A structure having a semiconductor material film formed graphene material layer that is disposed on a substrate is provided. The structure consists of a heterostructure comprising a semiconductor material film, a substrate, and a graphene material layer consisting of one or more sheets of graphene situated between the semiconductor material film and the substrate. The structure also can further include a graphene interface transition layer at the semiconductor material film interface with the graphene material layer and/or a substrate transition layer at the graphene material layer interface with the substrate.

### CROSS-REFERENCE

This application claims the benefit of priority to U.S. Provisional Patent Application No. 61/419,267 filed on Dec. 3, 2010, the entirety of which is hereby incorporated by reference into the present application.

### TECHNICAL FIELD

The present invention relates to a structure having a semiconductor material film on the surface of a graphene material layer that is formed on a substrate.

### BACKGROUND

The structure having semiconductor material film on graphene material layer can have application to numerous electronic structures, including light emitting device, lasers, photovoltaic cells, electroluminescent displays, digital circuits, analog-to-digital converters, digital-to-analog converters, mixed-signal circuit, fiber-optic receivers, and microwave amplifiers.

The structure has a semiconductor material film, a substrate, and a graphene material layer disposed on the substrate between the semiconductor material film and the substrate. The semiconductor material film is formed in at least one area on the surface of the graphene material layer.

One of the critical parameters for structures is the graphene material layer sheet resistance. A low graphene material layer sheet resistance can enable light-emitting devices and lasers with low forward voltage. A low graphene material layer sheet resistance is important to achieve an electronic device with high maximum frequency of operation as described in U.S. Nonprovisional application number 13/238,728 by F. J. Kub titled “Transistor Having Graphene Base” filed on Sep. 21, 2011 incorporated by reference herein in its entirety.

Graphene is a monolayer of conjugated sp² bonded carbon atoms tightly packed into a two-dimensional (2D) hexagonal lattice. One of the primary advantages of graphene is that it has extremely high intrinsic carrier (electron and hole) mobility and thus has extremely high electric conductivity and low sheet resistance. Graphene has the potential to have the highest conductivity and lowest resistivity of any material, with conductivity even higher than that of silver. See Chen et al., “Intrinsic and extrinsic performance limits of graphene structures on SiO₂,” Nature Nanotechnology 3, 206-209 (2008). While a single layer graphene has a zero voltage bandgap, a bi-layer graphene material layer consisting of two sheets of graphene can have a bandgap of approximately 250 electron volts. A single layer graphene sheet can also have bandgap by forming the graphene sheet into nanoribbons, patterned hydrogen absorption, or an antidot design. The signal layer graphene sheet can also have a bandgap by doping with appropriate atoms. See R. Balog, et. al. “Bandgap opening in graphene induced by patterned hydrogen absorption,” Nature Materials, Vol 9. pp 315-319, (2010).

For example, experimental results indicate that the resistivity of a single sheet of graphene approximately 3 angstrom thick grown on the silicon face of SiC has a sheet resistance on the order of 750 ohm/square to 1000 ohms/square, while a graphene sheet grown on the surface of copper can have a sheet resistance of approximately 1200 to 1500 ohms/square. In some cases, the sheet resistance of few sheets of graphene can be even less, as little as 100 ohms/square. Chen et al., supra.

The high electrical conductivity of graphene allows the use of an extremely thin graphene material layer, even one comprising only a single graphene sheet and having a thickness of approximately 0.28 nm for a single sheet of graphene. Use of such a thin graphene material layer reduces the forward voltage of light emitting device. the transit time of electrons through the graphene material layer and also reduces the energy loss of hot electrons in transiting the thin graphene material layer material. In addition, the high velocity of electrons in the graphene material layer can lower the graphene material layer transit time. Thus, the semiconductor structure with a graphene material can provide devices with advantageous properties.

One method of forming graphene on a surface is described in U.S. Provisional application No. 61/472,752 by F. J. Kub, T. A. Anderson, B. Feygelson titled “Growth of Graphene on Arbitrary Substrate,” filed on Apr. 7, 2010 incorporated by reference herein in its entirety.

The graphene material layer will typically consist of grains with dimensions that can range from nanoscale to multiple micron dimensions. The graphene material layer can consist of nanographene size dimensions. The graphene material layer can also consist of sheets that are substantially vertically aligned.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

One aspect of the present invention is generally directed to a structure a heterostructure comprising a semiconductor material film, a substrate, and a graphene material layer between the semiconductor material film and the substrate. The semiconductor material film typically contacts a first surface (first side) of the graphene material layer in at least one area of the graphene material layer first surface to form a semiconductor material film/graphene material layer interface (heterojunction). The substrate contacts the graphene material layer at a second surface (second side) thereof opposite the first surface to form a graphene material layer/substrate interface (heterojunction). An optional graphene interface transition layer can be formed between the semiconductor material layer and the graphene material layer. An optional substrate transition layer can be formed between the graphene material layer and the substrate. The structure typically has at least two electrode contacts and can have three or more electrode contacts.

Another aspect of the present invention is directed to a method of forming such a structure comprising providing a substrate, forming an optional semiconductor transition layer, forming a graphene material layer on the substrate, forming an optional graphene interface layer, forming a semiconductor material film on the graphene material layer, and forming electrodes to the semiconductor material film and at least one additional electrode to a second semiconductor material layer, a graphene material layer, or a substrate.

Another aspect of the present invention is directed to a photovoltaic devices or a light emitting devices, including the formation of a semiconductor material film on a graphene material layer on a substrate. An electrode contact is made to the semiconductor material film and at least one additional electrode contact is made to a second semiconductor material layer, a graphene material layer, or a substrate. A p/n or p/i/n junction is made within the semiconductor material film for collection of photogenerated electron and hole carrier for a photovoltaic cell or for injection of hole and electron carriers into an optional multiquantum well region to form a light emitting device. For an embodiment that is implemented using organic semiconductors, polymer semiconductors, or liquid crystalline polymers, crystalline polymers or multicrystalline polymers, the structure would not have a multiple quantum well region.

The foregoing and other features and advantages of the present invention will be apparent from the following, more particular description of a preferred embodiment of the invention, as illustrated in the accompanying drawings.

### BRIEF DESCRIPTION OF THE DRAWINGS

FIG. 1 depicts aspects of a general exemplary embodiment of a structure having a graphene material layer in accordance with the present invention.

FIGS. 2A-2B depict several exemplary embodiments for the graphene material layer. The graphene material layer can consist of one or more graphene sheets, one or more graphene oxide sheets, one or more fluorocarbon sheet, one or more functionalized graphene sheet, or combinations thereof in accordance with one or more aspects of the present invention.

FIGS. 3A-3D depict several exemplary embodiments for the graphene interface transition layer in accordance with one or more aspects of the present invention.

FIGS. 4A-4E depict several exemplary embodiments for the semiconductor material film in accordance with one or more aspects of the present invention.

FIG. 5 depicts several exemplary approaches to create nucleation sits for the growth of the semiconductor material film.

FIG. 6 depicts an exemplar formation of nucleation sites at the edge of an etched opening silicon oxide that is used for the selective deposition of a semiconductor material layer.

FIG. 7 depicts an exemplary description of the use of a graphene interface transition layer that has a conduction band minimum potential level intermediate between the conduction band minimum in the semiconductor material layer and the conduction band minimum in the graphene material layer to provides an intermediate potential level that aids in the injection of electrons from the graphene layer into the semiconductor material layer.

FIG. 8A depicts an exemplary embodiment of a light emitting device having a graphene material layer with the metal electrode contact to the graphene material layer.

FIG. 8B depict a second exemplary embodiment of a light emitting device having a graphene material layer with the metal electrode contact to the N-type semiconductor material layer.

FIG. 9 depicts an exemplary embodiment of a light emitting device having a graphene material layer grown on a metal layer on a substrate in accordance with one or more aspects of the present invention.

FIG. 10 depicts an exemplary embodiment of a light emitting device having a graphene material layer grown on a metal foil substrate in accordance with one or more aspects of the present invention.

FIG. 11 depicts an exemplary embodiment of a light emitting device having semiconductor nanowires grown on graphene material layer that are merged into a continuous semiconductor material layer.

FIG. 12 depicts a an exemplary embodiment of a photovoltaic device light having a semiconductor material film grown on a graphene material layer on a glass substrate in accordance with one or more aspects of the present invention.

FIG. 13 depicts a an exemplary embodiment of a photovoltaic device light having a semiconductor material film grown on a graphene material layer that is grown on a metal foil substrate in accordance with one or more aspects of the present invention.

FIG. 14 depicts an exemplary embodiment of a device that has substantially vertically orient graphene material layer in accordance with one or more aspects of the present invention.

FIG. 15 depicts aspects of a process to bond a semiconductor material layer to a copper heat sink/mount, remove the substrate and form a light emitting device.

FIG. 16 depicts aspects of a process to bond a semiconductor material layer to a support material, remove the substrate and transfer to a flexible polymer substrate.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The present invention provides a two-terminal light emitting device having a graphene material layer and a two-terminal photovoltaic device having a graphene material layer.

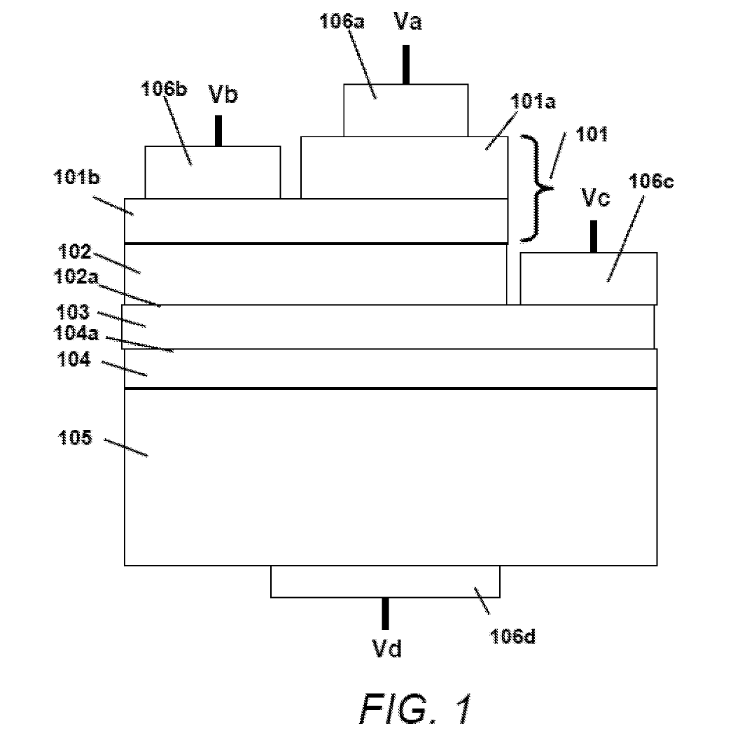

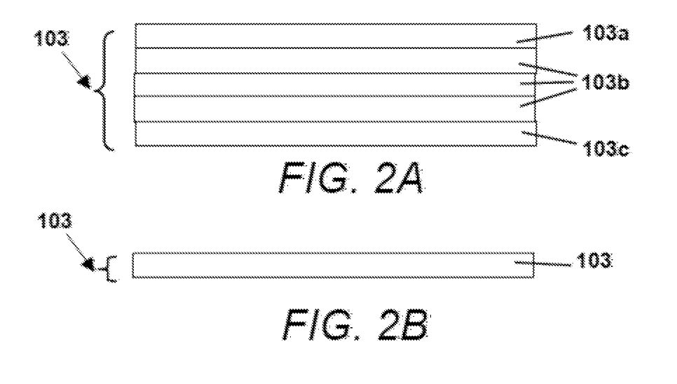

The structure of the present invention consists of a heterostructure comprising a semiconductor material film 101, a substrate 105, and a graphene material layer 103 between the semiconductor material film and the substrate as shown in FIG. 1. The semiconductor material film 101 typically contacts a first surface of the graphene material layer 103a in at least one area of the graphene material layer. There can be a heterojunction 102a at the semiconductor material film/graphene material layer interface. The substrate 105 contacts the graphene material layer 103 at a second surface 103c thereof opposite the first surface 103a as shown FIG. 2A to form a heterojunction 104a at the graphene material layer/substrate. The graphene material layer 103 can have a first surface 103a, a second surface 103c and intermediate graphene sheets 103b. The sheets in the graphene material layer can also be graphene sheet, graphene oxide sheets, fluorographene sheets, fluoridated sheets, or functionalized sheets. An optional graphene interface transition layer 102 can be formed between the semiconductor material layer 101 and the graphene material layer 103. An optional substrate transition layer 104 can be formed between the graphene material layer 103 and the substrate 105. The structure typically has at least two electrode contacts and can have three or more electrode contacts. Each electrode contact can be either a metal contact or a combination of a transparent electrode contact and a metal contact. For the case of a conductive substrate for a device with vertical current flow, one of the electrode contact 106d can be made to the conductive substrate, one of the electrode contacts can be made to the semiconductor material layer 106a or 106b, and an optional electrode contact can be made to the graphene material layer 106c. In the case of a semi-insulating substrate or an insulating substrate, one or more contacts will be made to the semiconductor material layer 106a or 106b and one or more electrode contacts can be made to the graphene material layer 106c. The electrodes can be contacts for the conduction of electrical currents or contact for the injection and collection of spin signals. To reduce surface recombination which can be detrimental to performance, a passivation layer can be provided over exposed portions of the substrate, semiconductor material film and graphene material layers of the structure. The substrate can be flexible enabling electronic, electro-optical, light collecting, photovoltaic, or light emitting devices on a flexible substrate. The substrate can be selected to closely match the thermal expansion coefficient of the semiconductor material film. The substrate can be selected to have high thermal conductivity. The substrate can be selected to be optically transparent to backside illumination with detector devices on the frontside or optically transparent for light emitting device that emit light through the substrate. The substrate can be selected to have high carrier velocity, high critical field for electric field breakdown, and the substrate can be selected to be have a preferred bandgap (such as wide bandgap or narrow bandgap).

The structure of the present invention can also be formed with a multiple mesa structure so that each of the substrate 105, semiconductor material film 101 and graphene material layer 103 can be independently contacted. Thus, in some embodiments, to facilitate electrical contact to the graphene material layer, a semiconductor material film can be selectively grown in region 109 shown in FIG. 6 so that after selective growth of the semiconductor material film and after etching of the dielectric film 108, the surface of the graphene material layer is exposed so that a metal contact layer 106c can be deposited on the exposed graphene material layer. In other embodiments, to facilitate electrical contact to the graphene material layer 103, a material such as polysilicon can be deposited on the surface of the graphene material layer, the surface of the polysilicon can be oxidized, the polysilicon can be photolithography patterned and then etched with approximately vertical sidewalls to the graphene material layer surface formed, a dielectric spacer formed on the sides of the polysilicon layer using reactive ion etching (RIE), and semiconductor material film selectively deposited (epitaxially grown) in the opening in the polysilicon layer on the surface of the graphene material layers as is known by those skilled in the art.

The following terms are used in the present disclosure. It should be noted, however, that the definitions presented are for ease of reference only and are not intended to limit the scope or spirit of the inventions described herein

A negative energy gap material has a bandgap energy separation between the valance band and the conduction band less than 0 meV.

A zero-bandgap layer material has a bandgap energy separation between the valance band and the conduction of 0 meV,

A semimetal material has a bandgap energy separation between the valance band and the conduction of 100 meV,

A narrow bandgap material has a bandgap energy separation between the valance band and the conduction band less than 400 meV

A moderate bandgap material has a bandgap energy separation between the valance band and the conduction band less than 2 eV but more than 400 meV

A wide bandgap material will typically have a bandgap energy separation between the valance band and the conduction band of more than 2 eV.

A semimetal has a resistivity value between 10⁻⁷ ohm-cm and 0.0005 ohm-cm.

A semiconductor material has bulk resistivity value between 0.0005 ohm-cm and 10¹⁰ ohm-centimeter.

A semi-insulator material has bulk resistivity value between 10⁶ to 10¹⁰ ohms. The semi-insulator material is semiconductor material.

Insulator material has bulk resistivity value between of 10¹⁰ to 10²² ohm-centimeter.

Functionalized graphene sheet has atoms or molecules adhered (bonded) to the first surface of the graphene sheet, graphene oxide sheet, fluorographene sheet or fluorinated graphene sheet. Atoms that can be adhered to the first surface of a graphene sheet include oxygen, nitrogen, hydrogen, bromine, calcium and other molecules known to those skilled in the art. Molecules that can be adhered to the surface of a graphene sheet can be one of carboxyl or amine molecules or other molecules know to those skilled in the art.

sp2 bonded silicon material layer (silicene) has hybridized bond orbitals with trigonal planar configuration.

sp2 bonded germanium material layer (germanene) has hybridized bond orbitals with trigonal planar configuration.

Fluorographene material layer is a graphene with attached fluorine atoms

III-nitride refers to a semiconductor alloy from the InAlGaN system that includes at least nitrogen and another alloying element from group III. AlN, GaN, AlGaN, InGaN, InAlGaN, or any combination that includes nitrogen and at least one element from group III are examples of III-nitride alloys.

sp3 material has sp3 hybridized bond orbitals with a tetrahedral symmetry

sp2 material has hybridized bond orbitals having a trigonal planar symmetry. Each carbon atom within graphene sheet has three nearest neighbors within the graphene sheets.

Graphene sheet with pi-bonds on the surface are non-reacting material and typically form only weak bonds to atom deposited on the surface of graphene sheet. Opening the pi-bond changes the bonding from sp2 to sp3 and provides bond sites available for reaction.

An organic semiconductor is an organic material with semiconductor properties.

A polymer semiconductor is an organic material with semiconductor properties.

The present invention will now be described in more detail below with reference to the attached figures which form a part of the disclosure herein.

FIG. 1 depicts an exemplary general structure of a semiconductor material film formed on graphene material layer on a substrate in accordance with the present invention.

In the exemplary structure shown in FIG. 1, a graphene material layer structure in accordance with the present invention includes a semiconductor material film 101, a substrate 105 and a graphene material layer 103 intermediate the semiconductor material film 101 and the substrate 105 and forming interfaces therewith. The semiconductor material film 101 can have two or more semiconductor material layer such as 101a and 101b. The semiconductor material layers can be doped with N-type dopants, doped with P-type dopants, or can be undoped. Semiconductor material film 101 typically contacts a first surface of graphene material layer 103 to form an heterojunction 102a at the semiconductor material film/graphene material layer interface, while substrate 105 typically contacts graphene material layer 103 at a second surface thereof opposite the first surface to form a graphene material layer/substrate interface (heterojunction) 104a. One or more of the semiconductor material layers within the semiconductor material film can be an insulator layer. In the preferred embodiment, there is at least one semiconductor material layers.

For some embodiments, it is desirable that the material for the semiconductor material film 101 be deposited in a patterned selective growth approach to facilitate electric contact to the graphene material layer material 103 layer by etching a dielectric layer that was used to define the regions for the selective semiconductor material film layer to the graphene material layer. Subtractive etch approach are also possible for forming the semiconductor material film 101 structure, but care is needed in performing the subtractive etch to only etch the semiconductor material film and not etch the graphene material. The use of etch stop layers at the bottom of the semiconductor material layer adjacent to the graphene material layer can facilitate a subtractive etch process for etching the semiconductor material layer and stopping the etch at an etch stop layer prior to etching to the graphene material layer followed by etching of the etch stop layer to the graphene material layer.

In some embodiments, the structure can include a graphene interface transition layer 102 between the semiconductor material film 101 and the graphene material layer 103.

In some embodiments, a substrate transition layer 104 is disposed at the substrate interface with the graphene material layer 103 and substrate 105 to act as an etch stop layer, to reduce the series resistance between the graphene material layer and the substrate by lowering the potential barrier at the graphene material layer/substrate heterojunction to facilitate the transport of electrons that travel from the graphene material layer into the substrate.

The structure also includes metal electrodes Va 106a and optional metal electrode Vb 106b, Vc 106c, and Vd 106d configured to make electrical connection with semiconductor material film 101, graphene material layer 103, and substrate 105, respectively. In some embodiments, there can be two or more contact to the semiconductor material layer such as 106a and 106b. Which of the optional electrical connections is used for two terminal device structure for the device structure depends on whether second electrical contact is preferred to a portion of the semiconductor material film, to the graphene material layer, or to the backside of the substrate. The metal that is in contact with semiconductor material film 101 and graphene material layer material layer 103 can be selected so that the electrical connection is preferably an Ohmic electrical connection, while the metal that is in contact with substrate 105 can be selected to make an preferably Ohmic electrical connection to the substrate.

In operation, a voltage difference (potential difference) is affected between semiconductor material film electrode Va 106a and at least one of the electrodes Vb 106b, Vc 106c, or Vd 106d for the case that a P—N junction is forward biased, forward current flow between the two electrodes. In the case that a pn junction is reversed biased such as for a photodetector, a photogenerated current will flow between the two electrode contacts.

### Graphene Material Layer

The graphene material layer 103 can comprise one or more graphene sheets, one or more graphene oxide sheets, one or more fluorographene sheets, one or more graphane sheet, one or more functionalized graphene sheets, or combinations thereof. The graphene material layer 103 has a graphene sheet on the first surface, 103a, has a graphene sheet on the second surface 103c and can have intermediate graphene sheets 103b. In the exemplary structure shown in FIG. 2A, the graphene material layer has a graphene sheet on the first surface 103a, a graphene sheet on the second surface 103b and three intermediate graphene sheets 103b. A second exemplary embodiment is shown in FIG. 2B comprising one graphene sheet. Another embodiment of a graphene material layer is a material that has graphene oxide sheet or a fluorographene sheet on the first surface of the graphene material layer, a graphene sheet on the second surface of the graphene material layer, and one or more graphene sheets intermediate between graphene oxide sheet or fluorographene sheet on the first surface and the graphene sheet on the second surface. Other embodiments for the graphene material layer can have other arrangements for the stacking of graphene sheets, graphene oxide sheets, fluorographene sheets, or the functionalized graphene sheets. Each sheet of the graphene material layer can be selected for N-type or P-type doping characteristics, carrier density characteristics, zero-bandgap or non-zero bandgap characteristics, and mobility characteristics. The graphene material layer can have intercalated atoms or molecules between the graphene sheets such as intercalated hydrogen, intercalated oxygen, intercalated gold, intercalated boron, intercalated bromine, intercalated nitrogen, or other atoms or molecules. The intercalated atoms or molecules can change the doping characteristics and bandgap of each of the graphene sheets and can induce a non-zero bandgap in the graphene sheets. The graphene material layer can be formed on the surface of the substrate by epitaxial growth of a graphene material layer on the substrate (such as a SiC substrate, catalytic or transition metal film on a substrate, or catalytic or transition metal foil substrate), by growth of a graphene material layer on a second substrate and then transfer and bonding of the graphene material layer to the substrate, by deposition of a graphene material layer, or by growth of a graphene material layer at the interface between a metal layer and a substrate surface. The graphene material layer can have small bandgap (in the case of bi-layer graphene or doped graphene) or no bandgap (in the case of single-layer graphene).

Graphene material layer 103 may comprise one or more sheets of graphene that have N-type conduction properties (having predominantly electron conduction), one or more sheets that have P-type conduction properties (having predominantly hole conduction), or, in some embodiments, may comprise a layered structure having one or more sheets with N-type conduction properties and one or more sheets with P-type conduction properties, interlayered with one or more undoped sheets of graphene. In some cases, one or more of the top and the bottom graphene layers may be doped in a different way than the remaining graphene layers in the graphene material layer. The first surface of the graphene material layer 103a can be modified to optimize the density and characteristics of nucleation sites for the growth of a semiconductor material layer (or for growth of the optional graphene translation material) on the surface of the graphene material layer.

The use of graphene for the graphene material layer also allows a graphene material layer with a low sheet resistance that increases the maximum frequency of operation. One of the critical parameters for structures is the graphene material layer sheet resistance. A low graphene material layer sheet resistance can enable light-emitting devices and lasers with low forward voltage. A low graphene material layer sheet resistance is important to achieve an electronic device with high maximum frequency of operation. The graphene material layer is thin which that allows a short transit time for electrons traveling perpendicular through the graphene material layer.

Another key feature is that the graphene sheets are highly resistant to atoms diffusing vertically (perpendicular to the graphene sheet) through the graphene sheet. Thus, impurities that are in the substrate material (such as impurities in a metal foil) will not diffuse through the graphene sheet into a semiconductor material film (such as CdTe or GaN) that is grown on the graphene material layer on a metal foil. The impurities can degrade the minority carrier lifetime in photovoltaic devices or the luminescence in light emitting devices.

Another feature of the graphene material layer is that the high resistance to atoms diffusing through the graphene sheets is that atoms from the semiconductor material layer will nucleate on the graphene material layer rather than on the substrate material and thus the graphene sheet prevents a diffusion of the semiconductor material layer atoms into the substrate material.

During an epitaxial growth process, atoms are typically deposited on a substrate and the atoms diffuse along the surface of the substrate until they reach a nucleation site and bond at the nucleation site. Because graphene is primarily sp2 bonded with few unbonded bond, the deposited semiconductor material film atoms readily diffuse on the graphene sheet surface to a nucleation site. One advantage that the high diffusivity of atoms on the graphene surface is that the ability to diffuse large distance on the graphene surface without bonding to a nucleation site results in large grain size in the case of polycrystalline or highly oriented semiconductor material films. The large grain size will typically have higher minority carrier lifetime and higher luminescence efficiency within the large grain size material then for small grain size material. The large grain size is important for improving the photovoltaic cell efficiency materials such as CdTe, CdS, ZnTe, copper indium gallium selenide, copper zinc tin sulfide, copper zinc tin selenide, and for light emitter device for such materials as GaN, AlGaN, and InGaN.

The high resistance to atom diffusing through the graphene sheet from the substrate into the semiconductor material layer, will also allow a higher anneal temperature without the substrate atoms diffusing into the photovoltaic material or light emitting material. The higher anneal temperature will enable larger grain size and improved photovoltaic and light emitting materials. A capping layer such as PECVD silicon nitride can be deposited on the surface of the semiconductor material layer during the anneal process to prevent the surface of the semiconductor material layer decomposing during the high temperature anneal.

The enhanced lateral thermal conductivity of graphene can spread the thermal load to a larger area and thus reduce the thermal resistance. Finally, the use of graphene for the graphene material layer also can lower the structure turn-on voltage of the structure thereby reducing power dissipation within the structure.

### Semiconductor Material Film

The structure has a semiconductor material film 101 that can provide functions such as a source for carrier injection into the graphene material layer, a collector for carriers injected from the graphene material layer into the semiconductor material layer, as a source for electric field control of the graphene material layer, or as a current or spin transport layer that is electromagnetically coupled to the graphene material layer. The semiconductor material film can be one or more of a semiconductor layer, a semi-metal layer, a semi-insulating layer, a negative bandgap, a zero-bandgap layer, a narrow bandgap, an moderate bandgap, a wide bandgap material, a graphene material layer, a graphene oxide material layer, a fluorographene (fluorinated) material layer, a graphane material layer, an sp2 bonded silicon layer (silicene), and sp2 bonded germanium layer (germanene), an sp2 bonded silicon carbide material layer, an sp2 bonded germanium carbide material layer, a carbide material layer, a material layer with two-dimensional carrier transport parallel to the first surface of the graphene material layer, a material layer with low-dimensional carrier transport parallel to the first surface of the graphene material layer, a material with spin transport properties parallel to the first surface of the graphene material layer, or combinations thereof. One or more of the semiconductor material layers within the semiconductor material film can be an insulator layer. In the preferred embodiment, there is at least one semiconductor material layers. The semiconductor material film can be a single-crystal material, a highly ordered material, a polycrystalline material, a compliant material, a nanocrystalline material, a self-assembled nanocrystalline material, an aligned or random array of nanowire material perpendicular to the first surface of the graphene material layer, a spontaneous nucleated material, a spontaneously nucleated material having isolated grains of material, a glass, an amorphous material, an artificially structured material, a non-single crystalline material, an organic semiconductor material, a polymer semiconductor material, a liquid crystalline polymer material, a crystalline polymer material, a quasi-crystalline polymer material, or combinations thereof. The semiconductor material layer can be selected to produce a preferred conduction band potential barrier or valance band potential barrier for the semiconductor material film graphene material layer heterojunction.

The semiconductor material film can be one or more of a semiconductor layer, a semi-metal layer, a semi-insulating layer, a negative bandgap, a zero-bandgap layer, a narrow bandgap, and moderate bandgap, a wide bandgap material, a graphene material layer, a graphene oxide material layer, a fluorographene (fluorinated) material layer, a graphane material layer, a carbide material layer, a material layer with two-dimensional carrier transport parallel to the first surface of the graphene material layer, a material layer with low-dimensional carrier transport parallel to the first surface of the graphene material layer, a material with spin transport properties parallel to the first surface of the graphene material layer, or combinations thereof, such as those illustrated in FIGS. 4A-4E described in more detail below. One or more of the semiconductor material layers within the semiconductor material film can be an insulator layer. In the preferred embodiment, there is at least one semiconductor material layers.

Semiconductor material layers can be material layer such as one or more of AlGaN, GaN, AlIN, InGaN, InN, AlN, silicon, germanium, SiGe, silicene, germanene, ZrB₂, GaAs, InGaAs, InAs, ZnO, BN, InAsP, InP, InAlAs, InAs InGaSb, SiC, GaSb AlP, ZnS, ZrB2, GaP, AlSb, InSb, AlAs, InAsP, InP, CdSe, SnO2:F, ZnO, BN, In₂O₃:Sn, diamond, CdTe, CdS, ZnTe, copper indium gallium selenide, copper zinc tin sulfide, copper zinc tin selenide, ZnS, and copper oxide. The semiconductor material layer can also be an artificially structured material, a non-single crystalline material, an organic semiconductor material, a polymer semiconductor material, a liquid crystalline polymer material, a crystalline polymer material, and a quasi-crystalline polymer material. Examples of organic semiconductor material include PEDOT, PEDOT:PSS and Spiro-OMeTAD. The semiconductor material film can comprise one or more semiconductor layers. The growth temperature for semiconductor material film by either CVD, MOCVD, Plasma MOCVD, remote plasma MOCVD, ALE, MBE, plasma deposition, pulse laser deposition, solid phase epitaxy, liquid phase epitaxy, spin coating, spay coating is typically uses deposition temperature of room temperature to 1100 C. As examples of graphene interface material layer embodiments, FIG. 4A shows one semiconductor, semimetal layer, or polymer layer 101. FIG. 4B shows two semiconductor material layers, two semimetal material layers, or two polymer layers 101a, 101b. FIG. 4C shows one graphene sheet 101f. FIG. 4D shows a stack of a graphene sheet 101i on the first surface of the semiconductor material layer, a graphene sheet 101k on the second surface of the semiconductor material layer, and intermediate graphene sheets 101j between the first and second surface of the semiconductor material layer, and FIG. 4E shows one organic semiconductor, one polymer semiconductor, one liquid crystal polymer comprising the semiconductor material film.

### Optional Graphene Interface Transition Layer

As noted above, a graphene material layer structure in accordance with the present invention can optionally include a graphene interface transition layer 102 disposed at the semiconductor material film interface with the graphene material layer (semiconductor material film/graphene material layer interface) heterojunction 102a.

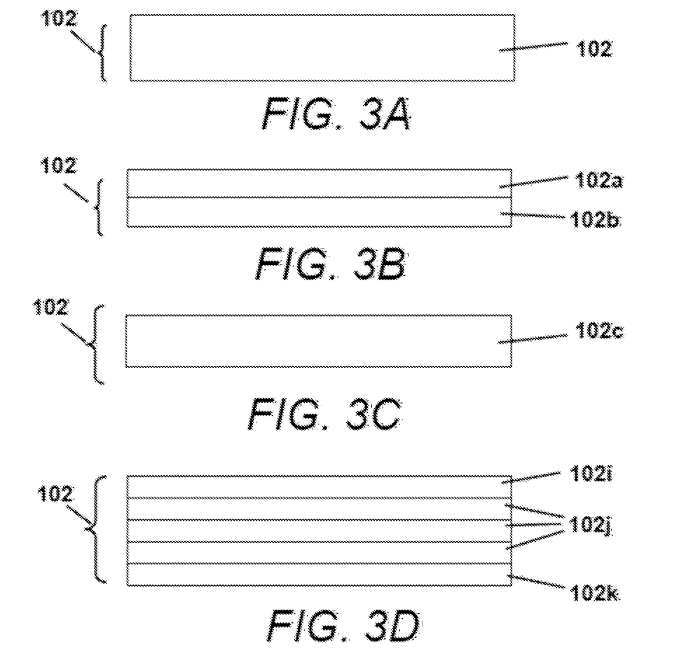

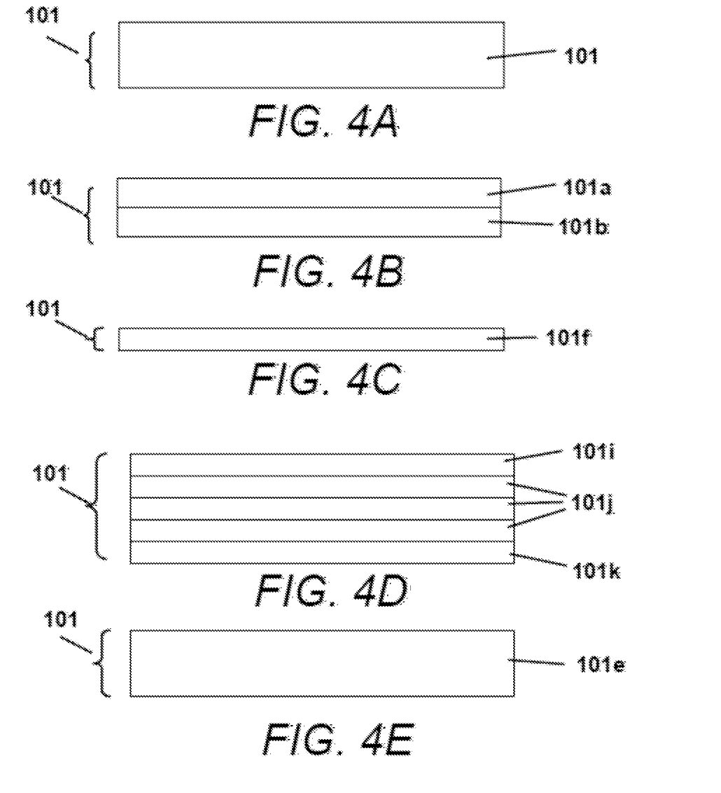

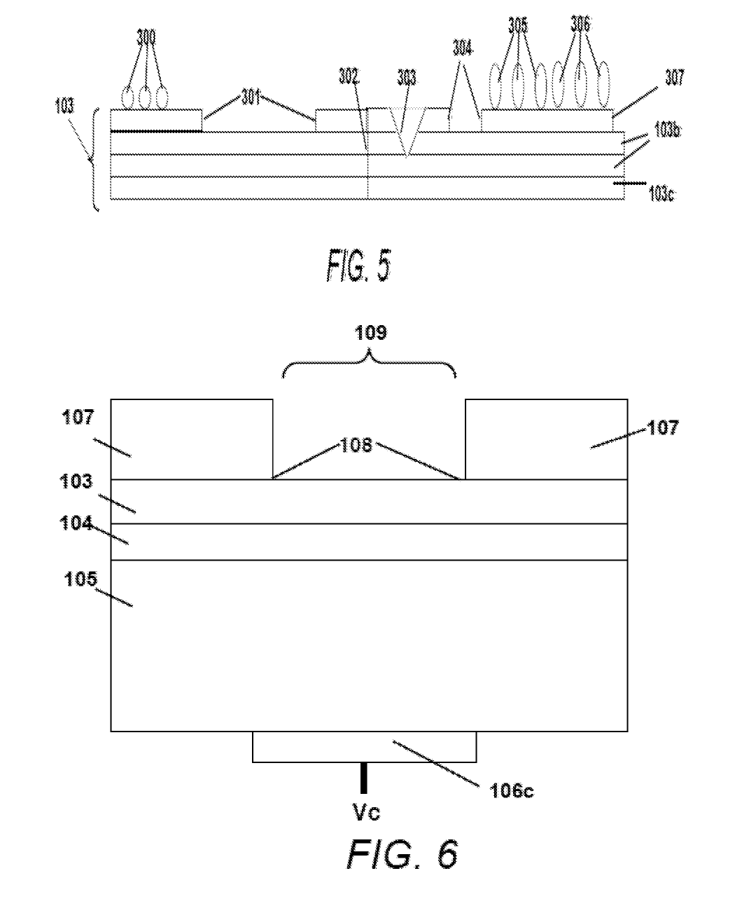

The graphene interface transition layer can comprise one or more semiconductor material layers, one or more semimetal material layers, one or more semi-insulating layers, one or more insulator layers, one or more graphene material layers, one or more doped graphene material layers, one or more modified graphene material layers, one or more fluorographene (fluorinated) graphene material layer, one or more functionalized graphene sheets, one or more graphene sheets, one or more graphene oxide sheets, one or more graphane sheets, one or more carbide material layer, one or more zirconium diboride layer, or combinations thereof, such as those illustrated in FIGS. 3A-3d described in more detail below. As examples of graphene interface material layer embodiments, FIG. 3A shows one semiconductor, semimetal layer, or polymer layer 102. FIG. 3B shows two semiconductor material layers, two semimetal material layers, or two polymer layers 102a, 102b. FIG. 3C shows one insulator layer 102c. FIG. 3D shows a stack of a graphene oxide sheet 102i on the first surface of the graphene interface transition layer, a graphene oxide sheet on the second surface of the graphene interface transition layer, and intermediate graphene oxide sheets 102j between the first and second surface of the graphene interface transition layer. The graphene interface translation layer can be a single-crystal material, a highly ordered material, a compliant material, a polycrystalline material, a graphene sheet, a graphene oxide sheet, a nanocrystalline material, nanowire material, a spontaneous nucleated material, spontaneously nucleated isolated grains of material, a glass, an amorphous material, an artificially structured material, a non-single crystalline material, a metal material, a polymer material, an organic semiconductor, polymer semiconductor, crystalline material, a liquid crystalline polymer material, a quasi-crystalline polymer material, or combinations thereof.

The graphene interface transition layer can consist of insulator material or have a doping type (P-type) that is opposite to the doping type (N-type) in the semiconductor material layer to allow reverse bias of the semiconductor material film relative to the graphene material layer.

The graphene interface transition layer 102 structure can provide functions such as an etch stop layer, a Bragg mirror consisting of a periodic structure of layered semiconductor material layers or layered dielectric material layers to reflect light back into the semiconductor material layer, an optimized nucleation material layer for the growth of the semiconductor material film, a potential smoothing layer for injection of carriers from the graphene material layer into the semiconductor material film, a barrier layer for tunnel injection or thermionic injection of carriers from the semiconductor material film into the graphene material layer, a blocking layer for the injection of carriers from the semiconductor material layer into the graphene material layer, an insulator layer, an insulator layer for the translation of the electric field in the semiconductor material film to the graphene material layer, an electromagnetic coupling structure between the semiconductor material film and the graphene material layer, an isolation and coupling layer between spin signals in the semiconductor material film and spin signals in the graphene material layer,

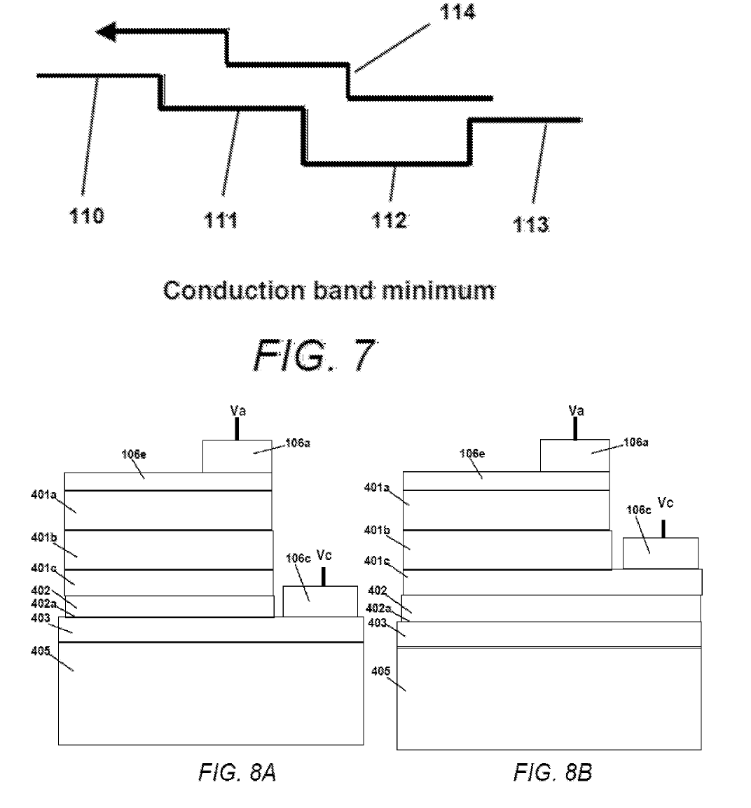

In the exemplary structure having shown in FIG. 8A, a semiconductor material film is disposed on a graphene material layer and the graphene material layer is deposed on a substrate. The semiconductor material film has a positive bias relative to the graphene material layer to allow injection of electrons from the graphene material layer into the semiconductor material film. In some embodiments, depending on the choice of the semiconductor material film used, an inherent potential barrier can exist between the graphene material layer and the N-type semiconductor material film because of the inherent graphene-semiconductor conduction band offset. An optional graphene interface transition layer can be bandgap grading to smooth the potential barrier that facilitates the transport of electrons from the graphene material layer into the semiconductor material film. In one embodiment, the optional graphene interface transition material layer can be selected to have an intermediate conduction band minimum 111 (conduction band minimum potential layer that is intermediate between the conduction band minimum value in the semiconductor material film 110 and the conduction band minimum value in the graphene material layer 112) as shown in FIG. 7. The conduction band minimum in the substrate is 113. Because of thermionic energy imparted to the electrons, they can transport over the potential barrier between the graphene material layer and the graphene interface transition layer into the graphene interface transition layer. After the electrons are in the conduction band minimum of the graphene interface transition layer 111, because of thermionic energy imparted to the electrons, they can transport over the potential barrier between the graphene interface transition layer and the semiconductor material film into the semiconductor material film 101. The probability for an electron to have sufficient thermion energy to transport over a potential barrier is exponentially related to the value of the potential barrier. There can be a very small probability of an electron having sufficient thermionic energy to inject over a potential barrier for a large potential barrier but can have some probability to inject to an intermediate potential level followed by an additional injection over second potential barrier in a hopping fashion.

The offset in potential of the conduction band minimum of the semiconductor material film 110 or conduction band minim in substrate 113 and the conduction band minimum of the graphene material layer 112 (potential barrier) can be estimated by using the difference in electron affinity of the two material systems.

TABLE I
Electron Affinity

| | | | Conduction Band | |
|---|---|---|---|---|
| Material | Electron Affinity | | Offset from Graphene | |
| Graphene | 4.5 | eV | | |
| CdSe | 4.95 | eV | −0.45 | eV |
| InAs | 4.9 | eV | −0.4 | eV |
| SnO2:F | 4.8 | eV | −0.3 | eV |
| InSb | 4.59 | eV | −0.09 | |
| ZnO | 4.5 eV or 4.35 | | 0.0 eV or 0.15 eV | |
| BN | 4.5 | eV | 0.0 | eV |
| CdTe | 4.5 | eV | 0.0 | eV |
| CdS | 4.5 | eV | 0.0 | eV |
| In2O3:Sn | 4.5 | eV | 0.0 | eV |
| InGaN | 4.1-4.59 | eV | −0.4 | eV |
| InAsP | 4.38 to 4.9 | eV | −0.4 to 0.12 | eV |
| InP | 4.38 | eV | 0.12 | eV |
| InGaAs | 4.1 to 4.9 | eV | −0.4 to 0.4 | eV |
| InAlAs | 4.1 to 4.9 | eV | −0.4 to 0.4 | eV |
| InGaSb | 4.1 to 4.59 | eV | −0.09 to 0.4 | eV |
| InN | 5.8 | eV | −1.3 | eV |
| Diamond | 4.2-4.5 | eV | 0.0 to 0.3 | eV |
| GaN | 4.1 eV or 4.3 eV | | 0.2 or 0.4 | eV |
| GaAs | 4.07 | eV | 0.43 | eV |
| Silicon | 4.05 eV or 4.29 | | 0.45 | eV |
| 4H—SiC | 4.05 | eV | 0.45 | eV |
| GaSb | 4.05 | eV | 0.45 | eV |
| Germanium | 4.0 | eV | 0.5 | eV |
| AlP | 3.98 | eV | 0.52 | eV |
| ZnS | 3.9 | eV | 0.6 | eV |
| GaP | 3.8 | eV | 0.7 | eV |
| AlSb | 3.65 | | 0.85 | eV |
| AlAs | 3.5 | eV | 1.0 | eV |
| AlN | 0.6 | eV | 3.9 | eV |

### Substrate

The substrate 105 can include any of a single-crystal material, a highly ordered material, a polycrystalline material, a non-single crystalline material, a ceramic material, a glass material, an amorphous material, a metal material, a metal foil material, a metal layer on a material, a polymer material, a flexible polymer material, an organic semiconductor, polymer semiconductor, crystalline material, a liquid crystalline polymer material, a quasi-crystalline polymer material, a composite material, a layered composite material, or combinations thereof. The substrate can comprise one or more material layers and in particular, one or more semiconductor material layers. The substrate can be conductive, semiconductor, semi-metal, semi-insulating, or insulating. The substrate can be selected to have optimized bandgap energy and selected breakdown critical electric field. The substrate can be selected to produce a preferred conduction band potential barrier or valance band potential barrier for the graphene material layer/substrate heterojunction. The substrate can be selected for mechanical strength. The substrate can be flexible. The substrate can be selected to have a thermal coefficient of expansion that closely matches the thermal expansion coefficient of the semiconductor material layer. The substrate can be selected to be compatible with the deposition temperature for the semiconductor material film. The substrate can be selected to have high thermal conductivity to enable an electronic device with high power capability. The substrate can be selected to be optically transparent to backside illumination with a detector devices or photovoltaic device on the frontside or optically transparent for light emitting device that emit light through the substrate.

The substrate can be selected for the property that the graphene material layer can be directly grown on the substrate. For example, the graphene material layer can be formed on the surface of a SiC substrate by epitaxial growth that involves the desorption of silicon atoms from the surface at temperatures in the range of 1000 C to 2000 C. In addition, graphene material layers can be grown on a metal layer on a material (such as glass, quartz, sapphire, or other substrate materials) or on a metal foil material by exposing the surface of the metal material to a carbon containing molecules such as methane and heating with a selected procedure to form graphene on the surface of the metal layer or metal foil material. For example, graphene material layer consisting of one or more graphene sheets can be formed on the surface of copper, nickel, nickel with gold catalyst, iron, iridium (and other metals) surfaces by chemical vapor deposition (CVD) growth using ambient containing methane and other carbon containing molecules. Amorphous carbon layer and polymer layers that can be converted to carbon material can also be deposited on the surface of the metal layer or the metal foil and an annealing procedure performed to form graphene material layer on the surface of the metal layer or metal foil material.

Substrate 105 may be fabricated from a semiconductor, a semimetal, a metal or one or more graphene sheets. In addition, substrate may consist of a single N-type material layer formed on a silicon, germanium, InP, GaAs, InAs, InGaAs, GaSb, SiC, GaN, ZnO, AlN, diamond, polycrystalline diamond, Chemical Vapor Deposited Diamond, composite of polycrystalline diamond and CVD diamond, low surface roughness polycrystalline diamond, or other diamond substrate material, boron nitride, metal film on a substrate, or metal foil substrate using homoepitaxial growth, heterojunction epitaxial growth, psuedomorphic growth, methomorphic growth, graded epitaxial growth, direct wafer bonding, or transferred substrate approaches or may further include an N− type material layer formed on the N+ type substrate material layer or substrate with or without a substrate transition layer 104 disposed within substrate 105 at the substrate interface with the graphene material layer 103.

### Optional Substrate Transition Layer

Also as noted above, in some embodiments, in accordance with the present invention can optionally include a substrate transition layer 104 interposed between the graphene material layer and the substrate. A heterojunction 104a is formed at the substrate interface with the graphene material layer (substrate/graphene material layer interface).

The optional substrate transition layer 104 can provide the function a Bragg mirror consisting of a periodic structure of layered semiconductor material layers or layered dielectric material layers to reflect light back into the semiconductor material layer, a graded potential barriers at the graphene material layer/substrate interface to facilitate transport of carriers from the graphene material layer to the substrate. The substrate transition layer can also be used to facilitate the bonding of the bonding of a graphene material layer to the substrate material for a graphene material layer transfer from a second substrate and bonding process. The substrate transition layer can be an etch stop layer for etching the substrate and stopping at the graphene material layer. The substrate transition layer can consist of insulator material or have a doping type (P-type) that is opposite to the doping type (N-type) in the substrate to allow reverse bias of the substrate relative to the graphene material layer.

As described in more detail below, the materials that can be used for the semiconductor material film, substrate, graphene interface transition layer, and substrate transition layer may depend on the offset in potential of their conduction band minimums with respect to the conduction band minimum of the graphene material layer. The offset potential is especially important for the determining how much energy the electrons in the graphene material layer must have to overcome the offset potential barrier at the substrate graphene material layer interface. It is often desirable that the substrate material has high saturated electron drift velocity. It is also desirable that the substrate material layer that is in contact with the substrate metal electrode connection facilitates the formation of low Ohmic contact resistance. It is also desirable that the semiconductor material film that is in contact with the semiconductor material film metal electrode connection electrode facilitates the formation of low Ohmic contact resistance.

There are multiple growth techniques of forming P-type graphene material layers. For example, graphene sheets that are grown on the carbon face of SiC are often P-type. See Y. M. Lin et al., “Multicarrier transport in epitaxial multilayer graphene,” Applied Physics Letters 97, 112107 (2010). Graphene grown by CVD on a copper film are also doped P-type. Graphene layers formed by any such technique can be used in a structure in accordance with the present invention.

### Formation of the Material Layers

Aspects of the formation of the semiconductor material film, graphene material layer, substrate, and optional substrate transition layer and graphene interface transition layer will now be described.

### Forming the Graphene Material Layer

The primary approaches for forming a graphene material layer on a substrate (or on a substrate translation layer on a substrate) are by 1) epitaxial growth on a substrate, 2) by Chemical Vapor Deposition (CVD) growth on a metal film on a substrate or by growth on a metal foil substrate, 3) by growth of a graphene material layer on a second substrate and then transfer and bonding of the graphene material layer to the substrate, 4) by deposition on a substrate by microwave plasma enhanced chemical vapor deposition as described by N. Soin, 5) by growth of graphene at the interface between a metal and a substrate as described by F. J. Kub, T. A. Anderson, B Feygelson, “Growth of graphene on Arbitrary Substrate,” Provisional Application No. 61/472,752 date Apr. 7, 2010, 6) or by other methods known to those skilled in the art. In some embodiments, the graphene material layer can be formed by epitaxial growth of graphene material on the surface of a SiC semiconductor with the SiC semiconductor also performing as a substrate. In other embodiments, the graphene material layer can be grown on the surface of a metal layer on a substrate or on a metal foil such as copper, nickel, iron, cobalt, and other metal foil material that is known to those skilled in the art. In still further other embodiments, the graphene material layer can be formed on a second substrate such copper, nickel, iron, cobalt, silicon carbide, and other substrates known to those skilled in the art and then be transferred and bonded to the surface of the substrate. In still further embodiments, the graphene material layer can formed on the surface of a substrate by deposition of a graphene material layer such as by microwave plasma enhanced chemical vapor deposition as described by N. Soin. The graphene material layer can also be formed at the interface between a metal film and a substrate.

The graphene material layer 103 can be formed on the substrate by growth of the graphene material layer on the substrate. The graphene material layer can be formed on the surface of a SiC substrate by epitaxial growth at temperatures in the range of 1100 C to 2000 C as is known to those skilled in the art. The graphene material layer can be grown on a metal surface such as copper, nickel, iron, iridium (and other metals) surfaces by chemical vapor deposition (CVD) growth using methane or by exposing the surface of the material to carbon containing molecules such and heating with a selected procedure that is known to those skilled in the art. Once the graphene material film is formed on the metal surface, the graphene/metal heterojunction can be exposed to high temperatures without degrading the graphene material film properties.

The graphene material layer can be formed by the transfer of and bonding of one or more sheets of graphene that is grown on the surface of a second substrate. In the transfer and bond approach, in a first step, graphene material consisting of one or more sheets of graphene are first grown on a substrate such as SiC, metal layer on a substrate, or metal foil substrate of copper, nickel or other substrates known by those skilled in the art using CVD, sublimation of silicon as is the case for SiC, or solution growth and by other techniques as known by those skilled in the art. In one example of the transfer and bond approach, in a second step, a heat releasable tape is adhered to the top surface of the graphene material that is formed on a substrate, and in a third step the heat releasable tape is lifted from the surface of the substrate with graphene material layer attached to the bottom surface of the heat releasable table.

The surface of the substrate material to receive the graphene sheet or sheets is suitably prepared for direct bonding of the graphene material layer. The process of suitably preparing the surface of the substrate material may include appropriate cleaning and in some cases by appropriate treatment for improving the bond strength of the graphene material layer to the surface of the substrate material.

In a fourth step 904, the surface of the graphene material layer is then brought into direct contact with the surface of the substrate material and the bonding forces present between the surface of the graphene sheet and the substrate material such as van der Waals bonding forces will bond the graphene sheet to the substrate material. The bond strength of the graphene material layer to the substrate material can be improved by appropriately charging the surface of the substrate and/or graphene material layer by exposing the surface to plasma or corona. The bond strength of the graphene material layer to the substrate material surface can also in some cases be improved by forming hydroxyl ions HO— on the surface of the substrate material. Once the graphene sheets are bonded to the substrate material, at a final step 905, the polymer tape is removed from the top surface of the graphene material layer so that the semiconductor material film or the graphene interface transition layer can be formed thereon.

The graphene material layer can comprise one or more graphene sheets, one or more graphene oxide sheets, one or more fluorographene sheets, or one or more graphane sheet and combinations thereof. One embodiment for the graphene material layer is for the graphene sheet on the first surface of the graphene material layer being optimized for forming heterojunction with the substrate (or substrate transition layer), the graphene sheet on the first surface of the graphene material layer being optimized for forming a heterojunction with the semiconductor material film (or graphene interface transition layer), and the graphene sheets that are not the surface graphene sheets (sheets within the graphene material layer) being optimized for low sheet resistance, hot carrier transmission property, high mobility, long spin coherence length, high carrier density, N-type or P-type doping, or other material property. For example, a graphene material layer with five graphene sheets may have the graphene sheet a the first surface of the graphene material layer optimized for providing nucleation sites for the growth of the semiconductor material film, the graphene sheet on the first surface of the graphene material optimized for bonding to the substrate and the three graphene sheet between the graphene sheets on the surface optimized low sheet resistance, hot carrier transmission property, high mobility, long spin coherence length, high carrier density, N-type or P-type doping. The process of optimizing the graphene sheets at the first and second surface of the graphene material layer for forming a heterojunction can degrade the sheet resistance, mobility, changed doping properties, or other material properties but leave the three center graphene sheets with optimal or near optimal sheet resistance, doping properties, and bandgap properties. The sheet resistance, carrier density or other properties of the graphene sheets that are not at the surface. For example, the process of optimizing the graphene sheet at the second surface of the graphene material for nucleation of the semiconductor material film by generating sp3 carbon bonds or step edges can degrade the sheet resistance of the second surface graphene sheet but can provide a high density of nucleation sites. The thickness of the above example graphene material layer with five sheet of graphene would be approximately 1.5 nm thick

The graphene sheet that as at the second surface of the graphene material layer can be optimized for bonding of the graphene material layer to the substrate (or substrate transition layer) by charging with a corona or plasma charge or by forming OH— bonds on the graphene surface. The graphene sheet that is on the first surface of the graphene material layer can also be optimized for low interface state by passivating dangling bonds with hydrogen or fluorine.

The graphene sheet that is on the first surface of the graphene material layer can be optimized for forming a heterojunction with the semiconductor material film (or graphene interface transition layer). A key aspect of optimizing the first surface graphene sheet is to generate nucleation sites for the growth of the semiconductor material film on the graphene sheet at the first surface of the graphene material layer. Other optimization are reducing the interface state density or modifying the heterojunction barrier height by doping with atoms such as bismuth.

It is sometimes the case that the mobility properties, doping properties, and/or bandgap of the graphene sheets on the first or second surface of the graphene material layer are modified as a result of the graphene sheet being in contact with a material layer immediately in contact with the graphene sheet. Thus, there can be an interaction between the graphene sheet on the first surface of the graphene material that is immediately adjacent to the semiconductor material film that can affect the mobility properties, doping properties, or bandgap of the second graphene sheet. Similarly, there can be an interaction between the graphene sheet that is on the first surface of the graphene material layer that is immediately adjacent to the substrate material that can affect the mobility properties, doping properties, or bandgap of that graphene sheet.

The number and properties each of the graphene sheets in the graphene material layer can be chosen to provide the selected graphene material layer properties such as low sheet resistance or the selected electron transmission probability through the graphene material layer.

In some embodiments, the preferred number of graphene sheets in the graphene material film is one graphene sheet. The graphene material layer can have special mobility, bandgap, and light absorption properties for the case of one graphene sheet. The graphene material layer with one graphene sheet will typically have zero bandgap, will have the highest mobility, and can have special spin transport properties. For the case of a graphene material layer with one graphene sheet, it can be desirable to minimize the number of sp3 carbon bonds that are created in forming the nucleation sites for growth of the semiconductor material layer.

The graphene material layer can contain graphene sheets that are N-type or contain graphene sheets that are P-type or contain both N-type and P-type graphene sheets. The graphene material layer can have an overall P-type or N-type characteristic depending on the mobility, carrier density, and number of P-type or N-type graphene sheets within the graphene material layer. The graphene material layer can have selected free carrier concentration and impurity doping to generate the selected free carrier concentration. There are multiple growth techniques of forming P-type graphene material layers. Graphene sheets that are grown on the carbon face of SiC are often P-type. Graphene sheets intercalatated with gold are P-type. Graphene sheet grown by CVD on a copper film are typically P-type. Graphene sheets grown on the carbon face of SiC are often P-type. Graphene grown on the silicon face of SiC are often N-type. N-type graphene can be formed by annealing in ammonia ambient or in nitrogen ambient.

The graphene material layer will typically consist of grains with dimensions that can range from nanoscale to multiple micron dimensions. The graphene material layer can consist of nanographene with nanoscale size dimensions. An approach to increase the density of nucleation sites for the growth of a semiconductor material layer includes forming or growing graphene with a high density of defects with the defects acting as nucleation site for the growth of the semiconductor material film (or graphene interface transition layer) Graphene that has small grain size will have sites for nucleation of graphene semiconductor material at the graphene material layer grain boundaries and thus can have a high density of nucleation sites. In addition, graphene material layers can be grown to have nanograins that will provide a high density of nucleation site for the growth of graphene material layer. For many device applications of semiconductor material on graphene, the important material property for the graphene material layer is that the graphene material layer has low sheet resistance. The graphene material layer sheet resistance will be degraded by the presence of grain boundaries, however, because the conductivity of the graphene material layer is so high, even graphene material with grain boundaries will have low sheet resistance.

The graphene material layer can also consist of sheets that are substantially vertically oriented few layer graphene sheet material. One approach to form the substantially vertical aligned few layer graphene sheet material can be formed by microwave plasma enhanced chemical vapor deposition as described by N. Soin, et. al. Materials Chemistry and Physics 129 2011 1051 1057. There are other approaches of forming substantially vertically aligned graphene material layers on a substrate. In this invention, semiconductor material layer can be deposited on with and within the regions in between the few layer graphene nanosheets to increase the surface area of interaction between the graphene material layer and the semiconductor material film.

In addition, for the purposes of this invention, it is necessary that the electrons are able to transport across the interface between the graphene material layer and the substrate material. It is thus generally desirable that if insulating material such as a native oxide or deposited insulator or grown insulator exists on the surface of the substrate material, the insulating material should be sufficiently thin that electrons can transit from the graphene material layer into the substrate (transit by tunneling) with only small perturbation to the electron transit across the interface.

In many cases it is desirable to not have an insulating material on the surface of the substrate material so that electrons can readily transit from the graphene material layer into the substrate. In this case, the surface of the substrate material is prepared in a suitable manner to minimize the native oxide on the surface. The surface of the substrate material can also be prepared to minimize the number of surface states and band bending on the surface of the substrate material. For example, it is known that forming fluorine atoms on the surface of GaN will remove the band bending at the surface of GaN.

There are other approaches for reducing surface states and band bending on the surface of the substrate material and thus at the interface of the graphene sheets/substrate material known by those skilled in the art. For example, in the case of a silicon surface, a process of exposing the surface to dilute hydrogen fluoride mixture in water removes the native oxide from the silicon surface and passivates the surface with a monolayer of hydrogen (hydrogen termination). The native oxide on a silicon carbide surface can also be largely removed by exposing the surface of silicon carbide to a mixture of dilute hydrogen fluoride and water. The native oxide on the GaN surface can be minimized by exposing the surface to high temperature ammonia gas, high temperature hydrogen gas, low temperature atomic hydrogen, or exposing the surface to liquid NaOH and water.

### Preparing the Graphene Material Layer Surface for Forming the Semiconductor Material Film

FIG. 5 depicts several exemplary approaches to form nucleation sites for the growth of the semiconductor material film (or growth of the graphene interface transition layer) on the graphene sheet on the first surface of the graphene material layer. The semiconductor material film (or graphene interface translation layer) is preferably epitaxially grown on the first surface of the graphene material layer. The approaches for forming nucleation sites include; 1) forming sp3 carbon bonds 305 in the first surface graphene sheet, 2) forming step edges 301 having sp3 carbon bonds and unbonded carbon bonds, 3) growing the graphene material with a selected density of defects 303 or selected grain size having grain boundaries 302, 4) passivating the unbonded sp3 bond, step edges, defects or grain boundaries with atoms such as hydrogen, oxygen, fluorine, or nitrogen 305, 5) functionalizing the surface of the first surface graphene sheet with molecules or atoms with ionic bonding 300 such as fluorine molecules absorbed on the surface of the graphene sheet, 6) performing a photolithography operation to pattern and etch the first surface graphene sheet (and optionally additional graphene sheets beyond the first surface graphene sheet) to create edges 304 on the graphene sheet that can act as nucleation sites, 7) self-assembly approaches such as nanosphere lithography consisting of forming nanoparticles on the graphene material layer surface and using the nanoparticles as masking layer for etching of one or more graphene sheet to create step edges 304 that can act as nucleation sites for the growth of the semiconductor material film, 8) patterned the graphene material layer by etching to the substrate and using the substrate surface for nucleation of semiconductor material film that lateral grows over the surface of the graphene material layer, 8) forming or converting the first surface graphene sheet to a graphene oxide sheet, 9), forming or converting the first surface graphene sheet to a fluorographene sheet, 10) forming or converting the first graphene sheet to a graphane sheet and 11) functionalizing the surface of the first surface graphene sheet with organic molecules, and other methods known to those skilled in the art, 12) nucleating vertically oriented semiconductor nanowire on the surface of the graphene material layer using metal seeded or non-seeded approaches included vapor-liquid-solid (VLS) approach that serve as nucleation layer for lateral and vertical growth semiconductor material film growth to form a continuous semiconductor material layer.

One approach to increase the number of nucleation sites for the growth of semiconductor material film (or graphene interface transition layer) on the graphene sheet on the first surface of the graphene material layers is to increase the density of sp3 hybridation in the graphene sheet on the first surface of the graphene material layer. There are a number of techniques for breaking the sp2 pi-bonds in the graphene sheet and forming sp3 bonds on the first surface graphene sheet. These techniques include exposing the surface of the graphene material layer to a plasma or UV generated atomic species such as atomic hydrogen, atomic oxygen, and atomic fluorine, exposing to UV ozone, exposing to an oxidation process, exposing to a hydrogenation process, exposing to fluorine, exposing to HNO3 acid, exposing to H2SO₄:HNO₃ acid, exposing to HNO3 and octadecylamine, exposing to dichlorocarbene, exposing to ion bombardment, exposing to ion milling, reactive ion etching, electron cyclotron resonance (ECR) etching, Inductively coupled plasma (ICP) etching, exposing to electron beam irradiation, exposing to laser irradiation, exposing to X-ray irradiation, or exposing to xenon difluoride gas, or other techniques known to those skilled in the art. The sp3 bonds can be passivated with carboxyl atoms by exposing graphene sheet to HNO₃ acid. The sp3 bonds can be passivated with by carbon-hydrogen, carbon-oxygen, carbon-fluorine, carbon-nitrogen bonds, or other atoms depending on the background ambient that is in the chamber of the process tool at the time the sp3 bonds are created by irradiation processes. In the case of creating in a vacuum, upon exposure to the ambient. The UV ozone, oxidation, and acid approach will tend to create carbon-oxygen bonds on the graphene material surface. The covalently bonded hydrogen, oxygen, fluorine, nitrogen, or hydrogen atoms will desorb from the graphene material layer surface at high anneal temperatures. If the anneal is in a vacuum, the broken sp2 bonds (that is, sp3 bonds) will tend to reheal and convert back to an sp2 bond. The process used to create the sp3 bonds can be performed in the same system that use used to grow the semiconductor material film (or graphene interface transition layer), can be performed in one chamber of a cluster tool and the semiconductor material layer growth performed in a second chamber of the cluster tool, or can be performed in separate process tools with exposure of the first graphene surface to the ambient during transfer between tools.

The first surface of the graphene material layer can have discontinuous sheets 307 with there being a high density of sp3 bond and unbonded carbon bonds at the edges (step edges) 301 of the discontinuous sheets of graphene. The sp3 bonds and the unbonded carbon bonds at the step edges can act as nucleation sites bonding of deposited atoms needed to form the semiconductor material film. The semiconductor material film atoms can initially nucleate at these sp3 bonds and the unbonded carbon bonds and then additional semiconductor material film atoms can grow laterally and vertically from the initial nucleation site. If the density of nucleation sites is sufficiently high, then the lateral extent of the semiconductor material film can merge at boundaries and form a continuous semiconductor material film on the surface of the graphene material. In addition, to the step edges occurring naturally, a high density of step edges with a high density of nucleation sites can be created by lithography 304 and other self-assembly approaches. For example, the step edges 304 can be formed by lithography to form patterns on the graphene material layer surface followed by an etch process to subtractive etch one sheets of the graphene material layer. Also, self-assembly approaches such as nanosphere lithography consisting of forming nanoparticles on the graphene material layer surface and using the nanoparticles as masking layer for etching of one or more graphene sheet to create step edges 304 that can act as nucleation sites for the growth of the semiconductor material film. Step edges can also be created on the surface of the graphene layer by exposing the graphene material layer to a process that reactively etches the graphene material layer. It will typically be the case that there are random defects, sp3 carbon bond sites, or weak spots in the graphene film where the reactive etching will initiate. The reactive etching will then spread laterally from this initial etching spot to enlarge the reactive etching area. Approaches that can reactively etch graphene include exposing the graphene material layer to atomic hydrogen, UV ozone, atomic oxygen, atomic fluorine, molecular fluorine, xenon difluoride, oxidation, reactive ion etching, or ICP etching. The reactive etching approach can also create random sp3 bond sites in the graphene sheet which will then be sites where the reactive etching can be enhanced and thereby form step etches. Other approaches such as sputtering or ion milling with sufficiently high energy ions will tend to etch (sputter) the graphene sheet in a uniform manner and create a high density of sp3 carbon bond. If the sputtering or ion milling ion energy is low, the ion impact on the graphene surface will create sp3 bonds. Electron beam irradiation as well as X-ray irradiation of the graphene sheet can also create sp3 bonds. Electron beam, focused ion beam, and ion beam lithography techniques can be used to pattern location well sp3 bonds will be created on the graphene sheet first surface 306. There can be a combination of processes to create sp3 bond and reactive etching. For example, an ion mill or e-beam process can be performed to create sp3 bond followed by an etching process to create step edges. Hydrogen molecule anneal can be preformed to create hydrogen bubbles beneath the graphene sheet and when a sufficiently high pressure is achieved, that exfoliate the top surface of the graphene sheet in selected regions.

There are additional approaches to create graphene sheet step edges that can act as nucleation sites for graphene material film (and graphene interface transition layer). These approaches include forming graphene nanoribbons, forming graphene antidot array, forming an artificially structured graphene sheet, or forming other suitable pattern to create a large number of step edge.

Another approach to increase the density of nucleation sites for the growth of a semiconductor material layer includes growing graphene with a high density of defects or grain boundaries. It can be preferable that the defect be formed in the graphene sheet of first surface of the graphene material layer. Graphene that has small grain size will have sites for nucleation sites at the grain boundary for the growth of the semiconductor material film. In addition, graphene material layers can be grown to have nanograins that will provide a high density of nucleation site for the growth of graphene material layer.

FIG. 6 depicts aspects for formation of nucleation sites 108 at the edge of an etched opening silicon oxide that is used for the selective growth of semiconductor material layer in the opening in dielectric film 107 in the region of the surface 109

Other reasons for optimizing the top most material layer include for electrical interaction, carrier transport across the interface, minimization of surface states at the interface, band bending at the interface, wafer bonding bond strength, van der Waals bonding, covalent bonding, ionic bonding; the graphene sheet that is adjacent with the substrate material being optimized for electrical interaction, carrier transport across the interface, surface states at the interface, band bending at the interface, wafer bonding bond strength, van der Waals bonding, covalent bonding, and ionic bonding with the substrate material; and the center graphene sheet or sheets having optimized mobility and thus low sheet resistance.

Another aspect of the process to grow semiconductor material film on the graphene material layer is to perform the initial semiconductor material film growth at a lower temperature and after the initial material growth, increase the temperature to increase the growth rate, grain size, and material properties. The temperature ramp to high temperature and the high temperature growth process can also act to anneal and improve the crystal quality of the layer deposited at lower temperature

In some embodiments, it can be preferred that the graphene material layer contain more than one graphene sheets with the top most graphene sheet (the sheet that is in contact with the semiconductor material film or the graphene interface transition layer) being optimized for nucleation of the growth of semiconductor material film (or graphene interface transition layer) on the surface of the graphene material layer. The advantage of a graphene material layer with multiple sheets is that even though the mobility, doping, and bandgap properties of the top most graphene sheet can be modified by the process used to improve the nucleation of semiconductor material film on the surface of the graphene material layer, the graphene sheets below the top most graphene sheet will typically not be affected by the processes used to optimize the nucleation sites on the surface of the top most graphene sheet. Thus, the graphene sheets beneath the top most graphene sheet can maintain the properties of high mobility, low sheet resistance, optimized impurity doping, optimized bandgap, and other preferred graphene sheet material properties.

The growth temperature for the nucleation layer for the semiconductor material film can be selected so that it is at a temperature that is either lower than the temperature for desorption of the hydrogen, oxygen, fluorine, or hydrogen deposition temperature or at a temperature such that oxygen, fluorine or hydrogen is desorbed from the surface. At low temperatures (approximately 25 C to 100 C) the removal of the foreign species can be enhanced using a remote plasma source or a within chamber plasma source. at selected atomic ion flux, substrate temperature and exposure time.

### Selective Growth of Semiconductor Material Layer on a Graphene Material Layer Surface

In some embodiments, it is desirable that semiconductor material film be deposited in a patterned selective growth area. One embodiment for selective growth is shown in FIG. 6. The growth of a semiconductor material film in a patterned selective growth area can not only facilitate the formation of an electric contact to the graphene material layer but also facilitate the nucleation of a continuous semiconductor material film within the patterned selective growth area. The patterned selective growth area is typically formed by depositing a silicon dioxide film on the patterned graphene material layer surface and then performing a photolithographic step to define selected areas where the silicon dioxide will be selectively etched to the surface of the graphene material layer. The patterned selective growth area can provide improved nucleation of a graphene material film within the patterned selective growth area because the sidewall edges of the oxide opening can provide nucleation sites for the initial growth of the semiconductor material layer. Also, the precursor material for the semiconductor material film can initially weakly attach to the surface of the oxide, diffuse laterally on the oxide surface and then deposit within the oxide openings. The increased flux of precursor relative to the available deposition area will increase the growth rate of semiconductor material within the oxide opening.

### Selective Growth of Semiconductor Material Layer on an Exposed Substrate Surface

A second approach that selective growth of the selective growth of the graphene material film is to first from the graphene material layer on a substrate surface, perform a lithography operation to define regions where the graphene material layer will be removed to the substrate surface and then epitaxially grow the graphene material layer using the substrate as the nucleation layer. The semiconductor material film can be grown in such a manner that the semiconductor material film initially nucleates on the substrate surface and then during the vertical growth of the semiconductor material layer also laterally grows horizontally so that portions of the graphene material layer is between the semiconductor material film and the substrate. The lateral growth of the semiconductor material film can proceed so that the patterned graphene material layer is entirely covered by the semiconductor material film. The semiconductor material film lateral growth can proceed from all surfaces where the substrate is exposed.

### Forming the Semiconductor Material Film

The structure has a semiconductor material film can that can provide functions such as source for carrier injection into the graphene material layer, a collector for carriers injected from the graphene material layer into the semiconductor material layer, as a source for electric field control of the graphene material layer, or as a current or spin transport layer that is electromagnetically coupled to the graphene material layer. The semiconductor material film can be a semiconductor layer, a semimetal layer, a semi-insulating layer, a modified graphene material layer, a graphene material layer, a material layer with two-dimensional carrier transport properties, a material layer with low-dimensional carrier transport properties, a material with spin transport properties, a negative bandgap, a zero-bandgap layer, a narrow bandgap, and moderate bandgap, or a wide bandgap material and combinations thereof. The semiconductor material film can be a single-crystal material, a highly ordered material, a polycrystalline material, a nanocrystalline material, nanowire material, a spontaneous nucleated material, spontaneously nucleated isolated grains of material, an organic semiconductor, polymer semiconductor, a liquid crystalline polymer material, crystalline material, a quasi-crystalline polymer material a polymer crystalline material, a liquid crystalline polymer material, a quasi-crystalline polymer material, a glass, an amorphous material, an artificially structured material, a non-single crystalline material, or combinations thereof.

The semiconductor material film can consist of a layered structure formed from more than one type of material layers.

The semiconductor material film can be formed by deposition of material layers or by direct bonding of semiconductor material film (and optional graphene interface transition layer material) onto the first surface of the graphene material layer. The deposition approaches can include epitaxial growth, vapor phase growth, chemical vapor deposition (CVD) growth, pulse laser deposition growth, plasma enhanced CVD growth, atomic layer epitaxy growth, atomic layer deposition growth, physical vapor deposition, sputter deposition, ion beam deposition, E-beam evaporation, spin coating, and other deposition techniques known to those skilled in the art.

An anneal process can be performed after the semiconductor material film deposition to increase the grain size, passivate defects, or reduce the semiconductor material film strain. The grain boundaries and dangling bonds within the semiconductor material film can be passivated with hydrogen atoms or fluorine atoms.

The semiconductor material film can be formed by deposition in different system then used to grow the graphene material layer, in the same system that is used to from the graphene material layer, or in a cluster tool in which the transport tool between deposition chambers has a purified ambient or vacuum so that the interface of the surface of the graphene material layer does not have contaminant deposited on the surface in the process of transporting from system used to grow the graphene material layer to the system used to deposit the semiconductor material film.

In some embodiments, the semiconductor material film is formed by epitaxial growth of a single-crystal material, a highly ordered material, a polycrystalline material, a nanocrystalline material, nanowire material, a spontaneous nucleated material, spontaneously nucleated isolated grains of material, an organic material, a polymer material, a polymer crystalline material, a liquid crystalline polymer material, a quasi-crystalline polymer material, a glass, an amorphous material, an artificially structured material, a non-single crystalline material, a metal material, or combinations thereof on the graphene material layer surface.

Many candidate semiconductor material films will have a large lattice mismatch to the graphene material layer. The semiconductor material film is ideally grown in a manner to best accommodate the lattice mismatch to the graphene material layer and minimize defects at the interface between the semiconductor material film and the graphene material layer. Candidate epitaxial growth approaches include metamorphic, psuedomorphic, a heteroepitaxial, or Van der Waals epitaxial growth approaches. In the Van der Waals epitaxial growth approach, the semiconductor material film acquires the lattice constant of the semiconductor material and is not lattice matched to the substrate. The semiconductor or semimetal material layer can be an a single crystal material layer, a highly oriented material layer, a polycrystalline material layer, or a compliant material layer approaches and other epitaxial growth approaches known to those skilled in the art. Van der Waals epitaxy approach can be used to aid in accommodating the large lattice mismatch.

The semiconductor material film will typically be a semiconductor having N-type or P-type doping.

The semiconductor material film may also be formed by wafer bonding semiconductor material film to the graphene material layer. The approaches include direct bonding semiconductor, semimetal, organic, or graphene sheet or sheets material to the surface of the graphene material layer. One approach is to transfer and bond N-type graphene sheet or sheets to a P-type graphene material layer. Other approaches include bonding a layered material having a thin semiconductor or thin semimetal layer on the surface. The thick portion of the layered material can then be selectively etched to leave a thin semiconductor or thin semimetal layer bonded to the surface of the graphene material layer.

An alternate approach to form a thin semiconductor, thin semimetal, or thin N-type graphene material layer bonded to the surface of the graphene material layer is to use a Smart Cut approach of implanting hydrogen or helium to a depth within the thin semiconductor or thin semimetal layer, or beneath the thin semiconductor or semimetal layer. A heating operation then causes the hydrogen and or helium to expand, and split off the thick portion of the layer material as known to those skilled in the art. The remaining portion of the thick layered material can then be etched to the thin semiconductor, semimetal, or N-type graphene material layer.

Annealing in molecular or atomic hydrogen or annealing with fluorine ambient can be performed to passivate the defects in the semiconductor metal film and at the interface of the graphene material layer.

Semiconductor material film can be one or more material layers of AlGaN, GaN, AlIN, InGaN, InN, AlN, silicon, germanium, SiGe, silicene, germane, GaAs, InGaAs, InAs, ZnO, BN, InAsP, InP, InAlAs, InAs InGaSb, SiC, GaSb AlP, ZnS, ZrB2, GaP, AlSb, InSb, AlAs, InAsP, InP, CdSe, SnO2:F, ZnO, BN, In₂O₃:Sn, diamond CdTe, CdSe, CdS, ZnTe, diamond, copper indium gallium selenide, copper zinc tin sulfide, copper zinc tin selenide, ZnS, copper oxide, SnO₂:F, In₂O₃:Sn. The semiconductor material film can also be have organic semiconductor material layers such as PEDOT, PEDOT:PSS. The silicene can be grown on ZrB₂ that is epitaxially grown on graphene material layer. The semiconductor material film can comprise one or more semiconductor layers, in some embodiments including a graphene interface transition layer. The growth temperature for semiconductor material film by either CVD, MOCVD, Plasma enhanced MOCVD, remote plasma MOCVD, ALE, MBE, plasma deposition, pulse laser deposition, solid phase epitaxy, or liquid phase epitaxy typically uses deposition temperature of 25 C (room temperature) to 1800 C.

The semiconductor material film can have varying dopant concentrations within each of the semiconductor material films and the dopant can be N-type, P-type or undoped. The semiconductor material layer in contact with the Ohmic electrode is often selected to have high N-type or P-type doping concentration to achieve low contact resistance. Any one of the semiconductor, semimetal, or dielectric material layers can be N-type doped, P-type, or undoped. One or more of the semiconductor material layers within the semiconductor material film can be an insulator layer. In the preferred embodiment, there is at least one semiconductor material layers. Any one of the substrate material layers near the semiconductor material layer/graphene material layer interface can be P-type doped, can contain a P-type delta doped layer, or can contain a graded P-type doped layer. The P-type doped layer, P-type delta doped layer, or graded P-type doped layer is one approach to implement a thermionic emission injection structure at the semiconductor material film/graphene material layer interface and to aid in allowing a negative voltage to be applied to the N-type semiconductor material film relative to the graphene material layer without a low resistance connection between the graphene material layer and substrate. A preferred operation mode is to be able to apply a reverse bias between the graphene material layer and substrate without excessive current flow because of a low series resistance between graphene material layer and substrate.

The semiconductor material film can have varying dopant concentrations within each of the semiconductor material layers, often having a high dopant concentration region in contact with the metal electrode connection to the semiconductor material film to achieve low contact resistance.

### Forming Graphene Interface Transition Layer

The graphene interface transition layer 102 can be formed by deposition of material layers or bonding of material layers. The bonded material layer can comprise one or more sheets of graphene oxide sheets, fluorographene sheets, or graphane sheets to implement an ultrathin insulator 101i, 101j, and 101k. It is very difficult to form ultra thin insulator on graphene and wafer bonded graphene oxide, fluorographene, or graphane sheets would allow an ultrathin insulator. The graphene interface transition layer can function as an insulator layer, a direct tunneling layer, a thermionic emitter layer, an electric field coupling material layer, an electron spin coupling layer, or an etch stop layer. A thickness for the graphene interface transition layer of less than approximately 1 nm is preferred for direct tunneling layer. A thickness for the graphene interface transition layer of in the range of than 0.25 nm to 30 nm is preferred for an electric field coupling layer between the semiconductor material layer and the graphene material layer, or an electron spin coupling layer between semiconductor material film layer and the graphene material layer.

The graphene interface transition layer can consist of one or more of insulator material layer, semi-insulating material layer, semiconductor material layer, graphene material, graphene oxide material, fluorographene material, or graphane material. The material layers can be undoped, compensated doped, or doped n-type or p-type.

One approach to forming the graphene interface transition layer is by transferring and bonding of one or more graphene oxide sheets, one or more fluorographene sheets, or one or more graphane sheet, or combinations thereof. In this approach, one or more graphene oxide sheets, one or more fluorographene sheets, or one or more graphane sheet are formed on a second substrate and then are transferred and bonded to the first surface of the graphene material layer. The graphene interface transition layer can be formed by sequentially transferring and bonding more that one graphene oxide sheets, fluorographene sheets, or graphane sheets to the first surface of the graphene material layer to achieve the selected thickness for the graphene interface translation material.

The graphene interface transition layer can also be formed by deposition of one or more material layers such as AlGaN, GaN, AlIN, InGaN, InN, AlN, silicon, germanium, SiGe, silicene, germane, GaAs, InGaAs, InAs, ZnO, BN, InAsP, InP, InAlAs, InAs InGaSb, SiC, GaSb AlP, ZnS, ZrB2, GaP, AlSb, InSb, AlAs, InAsP, InP, CdSe, SnO2:F, ZnO, BN, In₂O₃:Sn, diamond CdTe, CdS, ZnTe, Copper indium gallium selenide, copper zinc tin sulfide, copper zinc tin selenide, ZnS, copper oxide, Al₂O₃, BN, HfO₂, ZrB₂, graphene, fluorinated graphene, doped graphene insulator, silicon nitride, silicon oxide, AlN, MgO, layered combinations of insulating materials, and other insulator materials knows to those skilled in the art. The graphene interface transistor layer can be formed as one or more sheets of graphene oxide, one or more sheets of fluorographene, or one or more sheets of graphane. The insulator tunnel barrier material may be grown by atomic layer deposition, atomic layer epitaxy, CVD, PECVD, sputtering, ion beam deposition, and other techniques known to those skilled in the art. A preferred embodiment is that nucleation sites are generated on the first surface of the graphene material layer for the growth of the graphene interface transition material.

The graphene interface transition layer can be a single-crystal material, a highly ordered material, a polycrystalline material, a nanocrystalline material, nanowire material, a spontaneous nucleated material, spontaneously nucleated isolated grains of material, an organic material, a polymer material, a polymer crystalline material, a liquid crystalline polymer material, a quasi-crystalline polymer material, a glass, an amorphous material, an artificially structured material, a non-single crystalline material, or combinations thereof is deposited on the surface of the graphene material layer. In some embodiments, the optional graphene interface transition layer material can be formed on the surface of the graphene material layer by epitaxial growth.

The graphene interface transition layer can be designed to have a selected surface states density, fixed charge density, tunneling current characteristic, insulating characteristics, thermionic emission characteristics, and coupling characteristics.

An anneal process can be performed after the semiconductor material film deposition to increase the grain size, passivate defects, or reduce the semiconductor material film strain. The grains boundaries and dangling bonds within the semiconductor material film can be passivated with hydrogen atoms or fluorine atoms.

### Substrate

The substrate can be selected for mechanical strength and flatness properties. The substrate can be flexible. The substrate can be selected to closely match the thermal expansion coefficient of the semiconductor material film. The substrate can be selected to have high thermal conductivity. The substrate can be selected to be a mirror for generated light or to contain multiple layers that implement a Bragg reflection mirror structure. The substrate can be selected to be transparent backside illumination with detector devices on the frontside or for light emitting device that emit light through the backside

The substrate can also contain one or more material layers of metal, metal foil, silicon, germanium, GaN, AlN, AlGaN ZnO, BN, SiC, GaN, InP, InAs, silicon, germanium, GaSb, GaP, ZnS, InGaAs, InGaN, InAsP, InP, InGaAs, InAlAs, InGaSb, diamond, polycrystalline diamond, Chemical Vapor Deposited Diamond, composite of polycrystalline diamond and CVD diamond, low surface roughness polycrystalline diamond, or other diamond substrate material GaAs, SiC, GaSb, AlP, ZnS, GaP, AlSb, AlAs, InGaN, AlN, CdSe, InAs, SnO₂:F, InSb, ZnO, BN, CdTe, CdS, In₂O₃:Sn, InGaN, InAsP, InP, InGaAs, InAlAs, InGaSb, metal layer on diamond, glass, metal layer on glass, quartz, metal layer on quartz, ceramic, metal layer on ceramic, polycrystalline, metal layer on polycrystalline, single crystalline, amorphous, metal layer on amorphous, Bragg mirror layers on a substrate, etch stop layer on a substrate, or composites of material layers.

The substrate can have varying dopant concentrations within each of the semiconductor material films forming the substrate, typically having an upper substrate layer with a lower dopant concentration that can facilitate electric field spreading within the upper substrate and allow the application of a voltage bias between the graphene material layer and the substrate without avalanche carrier generation breakdown. A graphene material layer-to-substrate high breakdown voltage can be obtained by a selection of a combination of semiconductor material film bandgap, dopant concentration, and upper substrate width. The substrate can typically also be a high N-type dopant concentration substrate that can be used to form a low resistance Ohmic contact to the substrate electrode connection. Any one of the substrate material layers can be N-type doped. Any one of the substrate material layers near the substrate/graphene material layer interface can be P-type doped or can contain a P-type delta doped layer, or can contain a graded P-type doped layer. The P-type doped layer, P-type delta doped layer, or graded P-type doped layer is one approach to implement a thermionic emission barrier at the substrate/graphene material layer interface and to aid in allowing a positive voltage to be applied to the N-type substrate relative to the graphene material layer without a low resistance connection between the graphene material layer and substrate. A preferred operation mode is to be able to apply a reverse bias between the graphene material layer and substrate without excessive current flow because of a low series resistance between graphene material layer and substrate.

The substrate can also be implemented using a metal material combined with an tunnel insulator injection structure with the tunnel insulator material implemented with materials such as Al₂O₃, BN, HfO₂, fluorinated graphene, graphane, doped graphene insulator, silicon nitride, silicon oxide, AlN, MgO, layered combinations of insulating materials, and other insulator materials knows to those skilled in the art. The substrate can contain a substrate such as metal, silicon, GaN, AlN, AlGaN ZnO, SiC, GaN, InP, InAs, germanium, GaSb, diamond, GaP, ZnS, InGaAs, glass, quartz, ceramic, polycrystalline, single crystalline, amorphous.

Exemplary embodiments of a graphene material layer structure in accordance with the present invention will now be described, with reference in some cases to the Figures, which form a part of the present disclosure.

### Material and Device Structures.

### Embodiment 1

### Semiconductor Material Disposed on a Graphene Material Layer Grown on a Substrate

In this embodiment, the graphene material layer 103 can be first formed on the surface of a second substrate such as a metal foil substrate, SiC, or other substrate using processes known to those skilled in the art and then transferred to the substrate 105 using transfer and bonding processes known to those skilled in the art. Alternately, the graphene material layer 103 can be directly grown on a substrate 105 using MBE, Microwave Enhanced CVD, hydrothermal or solvothermal growth approaches, metal-seed catalyzed reduction of a carbon source, graphene grown at the interface between a metal layer and the substrate, deposition of graphene flakes, or deposition of graphene nanoplatelets, or other approaches for forming a graphene material layer on a substrate surface known to those skilled in the art.

In one embodiment, substrate 105 can be a flexible substrate. The substrate 105 can be selected to be optically transparent. The substrate can be selected to closely match the thermal coefficient of expansion of the semiconductor material film. The substrate can be selected to have high thermal conductivity. Normally epitaxial growth of single-crystal, or highly oriented, or polycrystalline material directly onto an amorphous substrate or highly defective substrate is not possible; however, a graphene material layer on an substrate would provide an adequate crystal lattice at the surface of the graphene material layer to allow epitaxial growth of a semiconductor material film with sufficient material quality for devices such light-emitting device, a photovoltaic device, a field effect transistor a bipolar transistor, a micoelectromechnical device, an optoelectronic device or a photonic integrated circuit that can be fabricated using the semiconductor material film that is grown on the graphene material layer on a substrate.

It is desirable that the semiconductor material film 101 growth process and anneal process be temperature compatible with the substrate 105 temperature capability. Low temperature approaches of forming graphene on a metal layer include plasma enhanced chemical vapor deposition, remote plasma enhanced chemical vapor deposition, MBE, nickel doped with gold as a catalyst or other methods known to those skilled in the art. The process of growing the semiconductor material film requires a growth process that is compatible with the temperature requirements of the substrate. Molecular beam epitaxy, atomic layer epitaxy, and plasma MOCVD can grow semiconductor material film on a substrate at a temperature compatible with the substrate. The semiconductor material film can also comprise organic semiconductor material, polymer semiconductor material, liquid crystal polymer material, crystalline polymer material, and quasi-crystalline polymer material. It is desirable that the thermal expansion coefficient of the substrate 105 material be selected to closely match the thermal expansion coefficient of the semiconductor material film 101.

To facilitate electric contact to the graphene material layer 103, an approach of using selective epitaxial growth can be used. For the selective growth approach as shown in FIG. 6, a silicon oxide layer is first deposited on the graphene surface, a photolithography operation is performed to define regions where the silicon oxide will be etched, the silicon oxide is etched to the graphene material layer surface, the resist is stripped to the semiconductor material film 101 is grown, and then the oxide can be etched to the graphene material layer without substantially etching the graphene material layer to deposit a metal electrode contact on the surface of the graphene material layer. The graphene material layer 103 can be doped P-type or doped N-type. A low graphene material layer sheet resistance that will lower the forward voltage drop or permit high frequency of operation for a device. The preferred embodiment would also have a low series resistance graphene material layer/semiconductor material film heterojunction 102a. An optional graphene interface transition layer can be used to lower the series resistance of the graphene material layer/semiconductor material heterojunction. One embodiment for a lower heterojunction series resistance is to use an optional graphene interface transition layer 102 material with an intermediate conduction band minimum potential level between the conduction band minimum potential levels of the semiconductor material film and the graphene material layer. An optional transparent electrode and metal contact electrode 106a, provide the anode voltage for the device. A second metal electrode 106c contact is made either to the graphene material layer 103 as shown in FIG. 1 or to the N-type GaN semiconductor material layer 101c as shown in FIG. 1. In operation, a forward bias is applied between electrodes 106a and 106c with current flow between the two electrodes in order to forward bias the light emitting or photovoltaic PN diode. Current can cross the graphene material layer/semiconductor material layer heterojunction for light emitting, photovoltaic devices, bipolar transistors, pn diode, microwave diode, and tunneling diode. A low series resistance graphene material layer/semiconductor material film heterojunction is preferred because the low series resistance heterojunction enable the low sheet resistance of the graphene material layer to parallel the sheet resistance of the N-type semiconductor material layer and lower the total lateral resistance. The preferred embodiment would have low sheet resistance N-type or P-type doped graphene material layer and low resistance graphene material layer/semiconductor material film heterojunction.

An alternate approach of making a device is to subtractive etch the semiconductor material film to a portion of the semiconductor material film 101 as shown in FIG. 1. For the case that a subtractive etch of the semiconductor material film to the graphene material layer is performed, a preferred approach is to have an etch-stop layer as one of the layers in the optional graphene interface transition layer 102 or in the semiconductor material layer 101.

While the description for this embodiment is for the epitaxial growth of III-nitride semiconductor material film on a graphene material layer, similar process methods and device structures can be used for other semiconductor material films as is known to those skilled in the art. While the description for this embodiment is for a light emitting device, similar process methods and device structures can be used for other electronic devices, optoelectronic devices, photonic integrated circuit, micoelectromechnical, and photovoltaic devices as is known to those skilled in the art.

Aspects of specific exemplary embodiments of a structure in accordance with the present invention are illustrated in FIG. 1.

### Embodiment 2

### Light Emitting Device on Graphene Material Layer Formed on a Glass Substrate

In this embodiment, the graphene material layer 403 can be first formed on the surface of a second substrate such as a metal foil substrate or SiC using processes known to those skilled in the art and then transferred to the substrate 405 using transfer and bonding processes known to those skilled in the art. Alternately, the graphene material layer 403 can be directly grown on a substrate using MBE, Microwave Enhanced CVD, hydrothermal or solvothermal growth approaches, metal-seed catalyzed reduction of a carbon source, or deposition of graphene flakes, deposition of graphene nanoplatelets, and other approaches for directly forming a graphene material layer on a surface known to those skilled in the art. In one embodiment, the substrate is a glass substrate. The glass substrate 405 can be a flexible substrate. The glass substrate 405 can be selected to be optically transparent at the wavelength of light generated in the optional multiple quantum well light emitter layers 401b. For an embodiment that is implemented using organic semiconductors, polymer semiconductors, or liquid crystalline polymers, the embodiment would not have a multiple quantum well layer 401b. Normally, epitaxially growing single-crystal, or highly oriented, polycrystalline III-nitride layers directly onto a glass substrate is not possible; however, a graphene material layer on a glass substrate would provide an adequate crystal lattice at the surface of the graphene material layer to allow epitaxial growth of a semiconductor material film with sufficient material quality for a light-emitting device. Light emitting devices are typically fabricated on a sapphire, SiC, or GaN substrate. The advantage of the use of a glass substrate is that the glass substrate enables larger size and lower cost light emitting devices and displays than can be obtained with a sapphire or GaN substrates. The light emitting device can be topside light emitting or bottom side light emitting.

It is desirable that the semiconductor material film 401 growth process and anneal process be temperature compatible with the glass temperature capability. The process of forming graphene on a glass substrate requires a graphene formation temperature that is compatible with the temperature requirements of the glass substrate 405. Low temperature approaches of forming graphene on a metal layer include plasma enhanced chemical vapor deposition, remote plasma enhanced chemical vapor deposition, nickel doped with gold as a catalyst or other methods known to those skilled in the art. The process of growing the semiconductor material film requires an epitaxial growth process that is compatible with the temperature requirements of the glass material. Molecular beam epitaxy, atomic layer epitaxy, and plasma MOCVD can grow III-nitride materials on glass substrate at a temperature compatible with the glass substrate. The semiconductor material film can also comprise organic semiconductor material, polymer semiconductor material, liquid crystal polymer material, crystalline polymer material, and quasi-crystalline polymer material. It is desirable that the thermal expansion coefficient of the glass substrate 405 material be selected to closely match the thermal expansion coefficient of the semiconductor material film 401.

To facilitate electric contact to the transparent N-type Graphene Material Layer 403, an approach of using selective epitaxial III-Nitride growth can be used. For the selective growth approach as shown in FIG. 6, a silicon oxide layer is first deposited on the graphene surface, a lithography operation is performed to define regions where the silicon oxide will be etched, the silicon oxide is etched to the graphene material layer surface, the resist is stripped to the III-Nitride semiconductor material film 401a, 401b, and 401c is grown, and then the oxide can be etched to the graphene material layer without substantially etching the graphene material layer to deposit a metal electrode contact on the surface of the graphene material layer. The semiconductor material film includes an N-type GaN layer 401c, an optional multiquantum well light emitter layer region 401b, and a P-type GaN contact 401a. For an embodiment that is implemented using organic semiconductors, polymer semiconductors, or liquid crystalline polymers, the embodiment would not have a multiple quantum well layer 401b. The semiconductor material film can include a III-nitride carrier blocking layer as part of the P-type layer and strain control layers as is known to those skilled in the art. The graphene material layer 403 is preferably doped N-type for low sheet resistance that will lower the forward voltage drop for the light emitting device at high forward currents. The preferred embodiment would have a low series resistance graphene material layer/semiconductor material film heterojunction 402a. An optional graphene interface transition layer can be used to lower the series resistance of the graphene material layer/semiconductor material heterojunction. One embodiment for a lower heterojunction series resistance is to use an optional graphene interface transition layer 402 material with an intermediate conduction band minimum potential level between the conduction band minimum potential levels of the semiconductor material film and the graphene material layer. An optional transparent electrode 106e and metal contact electrode 106a, provide the anode voltage for this light emitting device. A second metal electrode 106c contact is made either to the transparent N-type graphene material layer 403 as shown in FIG. 8A or to the N-type GaN semiconductor material layer 401c as shown in FIG. 8B. In operation, a forward bias is applied between electrodes 106a and 106c with current follow between the two electrodes in order to forward bias the light emitting PN diode. Holes are injected from the P-type GaN region 401a into the optional multiple quantum well layers 401b and electrons are injected from the N-type GaN semiconductor material layer 401c into the optional multiple quantum well region. The electrons and holes recombine in the optional multiple quantum well region and in the direct recombination process, emit light at a preferred wavelength. For an embodiment that is implemented using organic semiconductors, polymer semiconductors, or liquid crystalline polymers, the embodiment would not have a multiple quantum well layer 401b. Current must cross the graphene material layer/semiconductor material layer heterojunction in the light emitting device in FIG. 8A. In FIG. 8B, because the metal electrode contact is made to the N-type GaN layer, a low series resistance for the graphene material layer/semiconductor material film heterojunction is not required. However, a low series resistance graphene material layer/semiconductor material film heterojunction is preferred because the low series resistance heterojunction enable the low sheet resistance of the graphene material layer to parallel the sheet resistance of the N-type GaN layer and lower the total lateral resistance. The preferred embodiment would have low sheet resistance N-type doped graphene material layer and low resistance graphene material layer/semiconductor material film heterojunction for both the embodiment in FIG. 8A and embodiment in FIG. 8B

An alternate approach of making a light emitting device is to subtractive etch the III-Nitride material to the N-type GaN layer 401c as shown in FIG. 8B. For the case that a subtractive etch of the III-Nitride material layer to the graphene material layer, a preferred approach is to have an etch-stop layer a one of the layers in the optional graphene interface transition layer 402 or in the semiconductor material layer 401c.

The embodiment that is described is a P-up LED structure meaning that the P-type epitaxial layer is one of the last epitaxial layers to be grown. The process steps for an embodiment with a P-down LED structure where the P-type epitaxial layer is grown as one of the first epitaxial layers is similar to the P-up device structure except for a reversal of some of the epitaxial growth layer as is known by those skilled in the art.

While the description for this embodiment is for the epitaxial growth of III-nitride semiconductor material film on a graphene material layer, similar process methods and device structures can be used for other semiconductor material films as is known to those skilled in the art. While the description for this embodiment is for a light emitting device, similar process methods and device structures can be used for other electronic devices, optoelectronic devices, photonic integrated circuit, micoelectromechnical, and photovoltaic devices as is known to those skilled in the art.

Aspects of specific exemplary embodiments of a structure in accordance with the present invention are illustrated in FIGS. 8A-8B.

### Embodiment 3

### Light Emitting Device on Graphene on Metal Layer on a Glass Substrate

The approach to implement this embodiment is the same as described in Embodiment 2 except that the graphene material layer 403 is fabricated by growing a graphene material layers on a metal layer that is deposited on the substrate. The graphene material layer 403 can be formed on the surface of a catalytic or transition metal layer such as copper, nickel, or iron that is deposited on a substrate using processes known to those skilled in the art. In one embodiment, the substrate is a glass substrate. The process steps for forming this embodiment are similar to those described for embodiment 1.

While the description for this embodiment is for the epitaxial growth of III-nitride semiconductor material film on a graphene material layer, similar process methods and device structures can be used for other semiconductor material films as is known to those skilled in the art. While the description for this embodiment is for a light emitting device, similar process methods and device structures can be used for other electronic devices, optoelectronic devices, photonic integrated circuit, micoelectromechnical, and photovoltaic devices as is known to those skilled in the art.

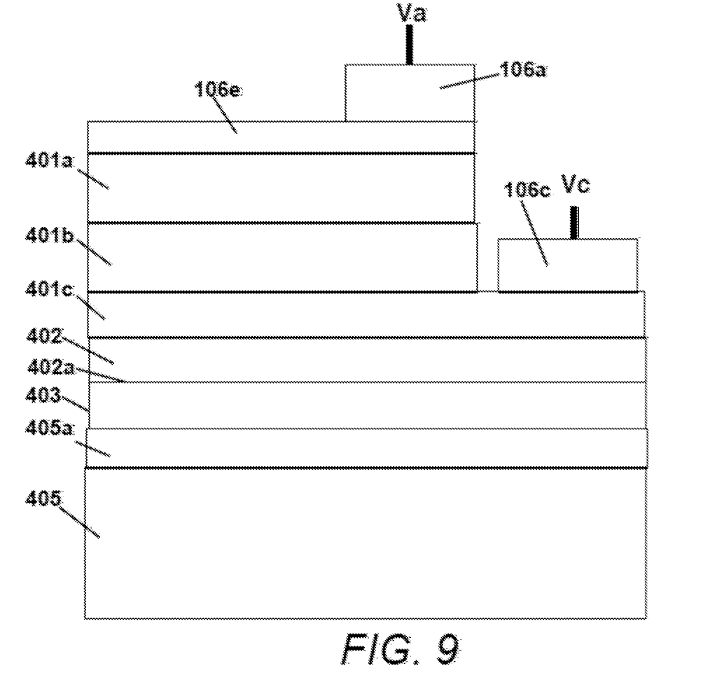

Aspects of specific exemplary embodiments of a structure in accordance with the present invention are illustrated in FIG. 9.

### Embodiment 4

### Light Emitting Device on Graphene on Metal Foil Substrate

The approach to implement this embodiment is the same as described in Embodiment 1, 2 and 3 except that the graphene material layer 503 is fabricated by growing a graphene material layers on a metal foil substrate 505. The graphene material layer 503 can be formed on the surface of a catalytic or transition metal foil substrate such as copper, nickel, iron, stainless steel or other metal foil substrates using processes known to those skilled in the art. The metal foil substrate 505 can be a flexible substrate. The metal foil substrate can be a composite substrate that can include the combination of a metal foil and an adhered polymer film. The adhered polymer film can provide additional mechanical strength and other properties known to those skilled in the art. The polymer film can be adhered after the graphene material growth process. The process of growing a graphene material layer 503 on the metal foil substrate in many embodiments require exposing the metal foil to a high growth temperature. The high growth temperature can make the foil even more flexible then a foil that has not be exposed to a high temperature anneal. The foil that has been exposed to a high temperature can have the characteristics of annealed metal foil. The metal foil substrate 505 surface can be prepared for selected or optimized growth of the graphene material layer 503. The metal foil substrate or the metal foil substrate surface can be annealed, polished, electropolished, chemically polished, electrodeposited, chemical mechanical polished, a metal foil with low surface roughness, annealed, or annealing at a higher temperature than the graphene material growth temperature, or other selection or optimization process known to those skilled in the art. The graphene material layer growth temperature is often in the range of 750 C to 1050 C. Lower growth temperatures can be achieved by doping the surface of the nickel foil with gold or using a plasma process for decomposing the carbon containing molecules in the gas ambient. Higher temperature then 1050 C can be used to grow larger metal grains within the metal foil. The metal foil surface can be cleaned prior to the graphene material layer growth process to remove any unwanted oxides or physiabsorbed contaminants by washing in acetic acid or deioized water or other cleaning step known to those skilled in the art. Hydrogen containing gas can be used in the growth process for the graphene material layer on a metal as is known to those skilled in the art. The pressure for growth of the graphene material layer on metal foil substrate can be selected for preferred graphene material layer properties. For example, graphene material layer grown on copper in a vacuum is often a single graphene sheet while a graphene material layer grown at an atmospheric or high pressure is often a few graphene sheets thick. Normally epitaxially growing single-crystal, highly oriented, or polycrystalline semiconductor material layer with high material properties on III-nitride layers directly onto a metal foil substrate 505 is not possible; however, a graphene material layer 503 on a metal foil substrate would provide an adequate crystal lattice at the surface of the graphene material layer 503 to allow epitaxial growth of a semiconductor material film with sufficient material quality for a light-emitting device. Light emitting devices are typically fabricated on a sapphire, SiC, or GaN substrate. The advantage of the use of a metal foil substrate is that the metal foil substrate enables larger size and lower cost light emitting devices and displays then can be obtained with a sapphire or GaN substrates. The light emitting device on a metal foil substrate is a top side emitting LED.

It is desirable that the semiconductor material film 401a, 401b, 401c growth process and anneal process be temperature compatible with the metal foil substrate 505 temperature capability. The process of forming graphene on a metal foil substrate requires a graphene formation temperature that is compatible with the temperature requirements of the metal foil substrate 505. Low temperature approaches of forming graphene on a metal layer include plasma enhanced chemical vapor deposition, or remote plasma enhanced chemical vapor deposition. The process of growing the semiconductor material film requires an epitaxial growth process that is compatible with the temperature requirements of the metal foil substrate material. Plasma MOCVD can grow GaN on metal foil substrate at a temperature compatible with the metal foil substrate material. It is desirable that the thermal expansion coefficient of the metal foil substrate 505 material be selected to closely match the thermal expansion coefficient of the semiconductor material film 401a, 401b, 401c. The remaining process steps for forming this embodiment are similar to those in embodiments 2 and 3.

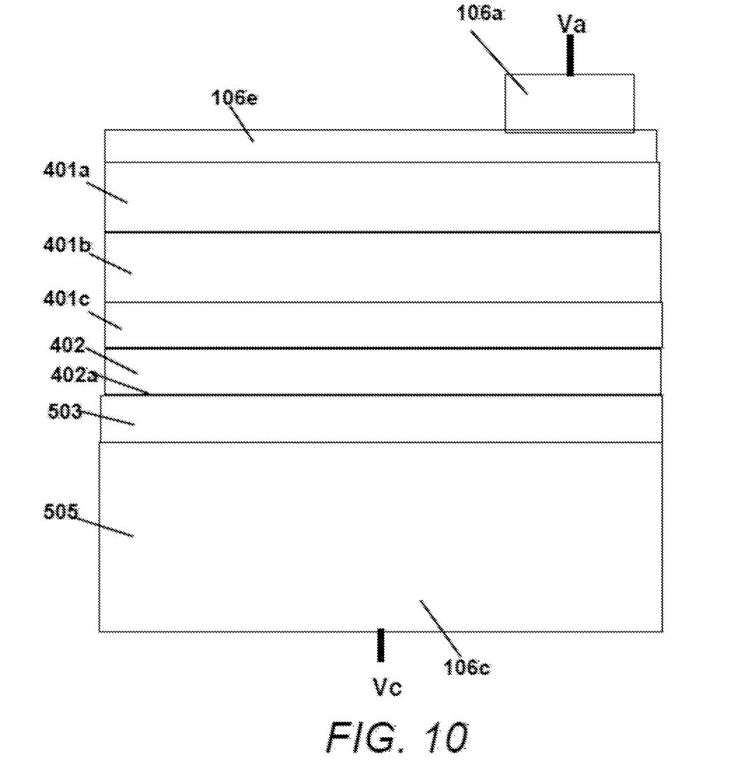

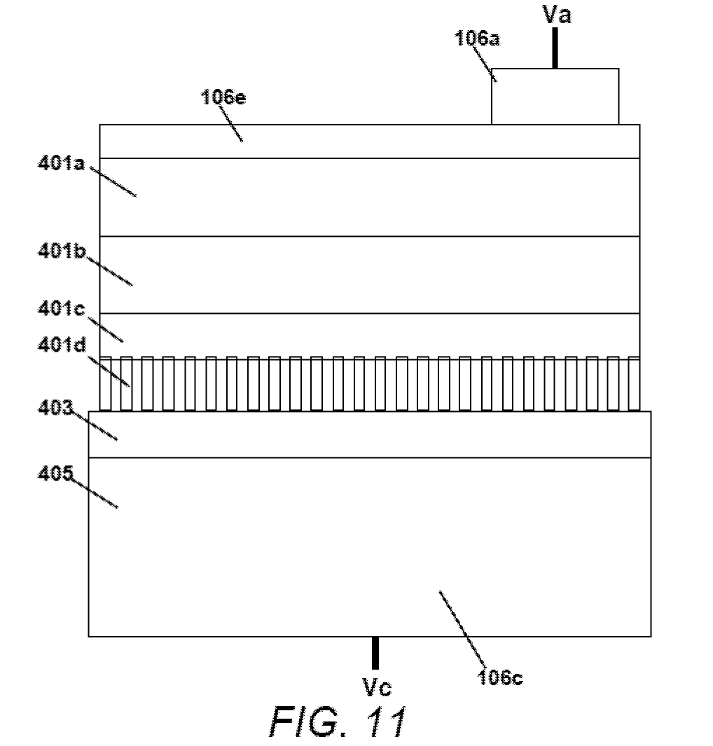

To facilitate electric contact to the transparent N-type Graphene Material Layer 403, an approach of using selective epitaxial III-Nitride growth can be used. For the selective growth approach as shown in FIG. 6, a silicon oxide layer is first deposited on the graphene surface, a lithography operation is performed to define regions where the silicon oxide will be etched, the silicon oxide is etched to the graphene material layer surface, resist is stripped the III-Nitride semiconductor material film 401a, 401b, and 401c is grown, and then the oxide can be etched to the graphene layer to deposit a metal electrode contact on the surface of the graphene material layer. The semiconductor material film includes an N-type GaN layer 401c, an optional multiquantum well light emitter layer region 401b, and a P-type GaN contact 401a. For an embodiment that is implemented using organic semiconductors, polymer semiconductors, or liquid crystalline polymers, the embodiment would not have a multiple quantum well layer 401b. The semiconductor material includes carrier blocking layers AlGaN layer as part of the P-type layer as is known to those skilled in the art. The graphene material layer 403 is preferably doped N-type for low sheet resistance to lower the series resistance of the graphene material layer/semiconductor material film heterojunction. The preferred embodiment would have a low series resistance graphene material layer/semiconductor material film heterojunction 402a. One embodiment for a lower heterojunction series resistance is to use an optional graphene interface transition layer 402 material with an intermediate conduction band minimum potential level between the conduction band minimum potential levels of the semiconductor material film and the graphene material layer. An optional transparent electrode 106ea and metal contact electrode 106a, provide the anode voltage for this light emitting device. A second metal electrode 106c contact is made either to the transparent N-type graphene material layer 403 or to the N-type GaN semiconductor material layer 401c. In operation, a forward bias is applied between electrodes 106a and 106c with current flow between the two electrodes in order to forward bias the light emitting PN diode. Holes are injected from the P-type GaN region 401a into the optional multiple quantum well region 401b and electrons are injected from the N-type GaN semiconductor material layer 401c into the optional multiple quantum well region. For an embodiment that is implemented using organic semiconductors, polymer semiconductors, or liquid crystalline polymers, the embodiment would not have a multiple quantum well layer 401b. The electrons and holes recombine in the optional multiple quantum well region and in the direct recombination process, emit light at a preferred wavelength. For an embodiment that is implemented using organic semiconductors, polymer semiconductors, or liquid crystalline polymers, the embodiment would not have a multiple quantum well layer materials. For the case that the metal electrode contact 106c is made to the graphene material layer, current must cross the graphene material layer/semiconductor material layer heterojunction in the light emitting device. In FIG. 10, because the metal electrode contact is made to the N-type GaN layer, a low series resistance for the graphene material layer/semiconductor material film heterojunction is not required. However, a low series resistance graphene material layer/semiconductor material film heterojunction is preferred because the low series resistance heterojunction enable the low series resistance of the graphene material layer to parallel the sheet resistance of the N-type GaN layer and lower the total lateral resistance. The preferred embodiment would have low sheet resistance N-type doped graphene material layer and low series resistance graphene material layer/semiconductor material film heterojunction.

An alternate approach of making a light emitting device is to subtractive etch the III-Nitride material to the N-type GaN layer 401c as shown in FIG. 10. For the case that a subtractive etch to the III-Nitride material layer to the graphene material layer, a preferred approach is to have an etch-stop layer a one of the layers in the optional graphene interface transition layer 402 or in the N-type III-Nitride semiconductor material layer 401c.

The embodiment that is described is a P-up LED structure meaning that the P-type epitaxial layer is one of the last epitaxial layers to be grown. The process steps for an embodiment with a P-down LED structure where the P-type epitaxial layer is grown as one of the first epitaxial layers is similar to the P-up device structure except for a reversal of some of the epitaxial growth layer as is known by those skilled in the art.

While the description for this embodiment is for the epitaxial growth of III-nitride semiconductor material film on a graphene material layer, similar process methods and device structures can be used for other semiconductor material films as is known to those skilled in the art.

While the description for this embodiment is for the epitaxial growth of III-nitride semiconductor material film on a graphene material layer, similar process methods and device structures can be used for other semiconductor material films as is known to those skilled in the art. While the description for this embodiment is for a light emitting device, similar process methods and device structures can be used for other electronic devices, optoelectronic devices, photonic integrated circuit, micoelectromechnical, and photovoltaic devices as is known to those skilled in the art.

Aspects of specific exemplary embodiments of a structure in accordance with the present invention are illustrated in FIG. 10.

### Embodiment 5

### Light Emitting Device on Graphene Material Layer Formed with Nanowire Array

The approach to implement this embodiment is the same as described in Embodiment 1, 2, 3, and 4 except that the semiconductor material film is formed by growing a III-nitride epitaxial layer on a nanowire nucleation layer 401d that is grown on the graphene material layer 403 shown in FIG. 11. In this embodiment, the nanowires can be grown by the process of vapor-liquid-solid (VLS) method that is known to those skilled in the art. A seed metal nanoparticle is typically deposited on the surface and the nanowire is grown from this metal nanoparticle seed. The metal nanoparticles seeds can be arranged in a regular array using photolithography approaches or can be implemented in a random array by randomly forming metal nanoparticle seeds on the surface of the graphene material layer. A high density of metal nanoparticles with a close spacing between nanoparticles can be formed. A high density of nanowire can also be formed in a non-seeded or self-seeded approach known to those skilled in the art. In the preferred embodiment, the nanowires are grown to a selected height and then the MOCVD growth process is modified so that the GaN material grows laterally and the GaN merge into a continuous film. The remaining processes for forming a light emitting diode are similar to those in embodiments 1, 2, 3, and 4.

While the description for this embodiment is for the epitaxial growth of III-nitride semiconductor material film on a graphene material layer, similar process methods and device structures can be used for other semiconductor material films as is known to those skilled in the art. While the description for this embodiment is for a light emitting device, similar process methods and device structures can be used for other electronic devices, optoelectronic devices, photonic integrated circuit, micoelectromechnical, and photovoltaic devices as is known to those skilled in the art.

Aspects of specific exemplary embodiments of a structure in accordance with the present invention are illustrated in FIG. 11.

### Embodiment 5

### Device on Graphene Grown on a Diamond Substrate Embodiment

In this embodiment, the substrate is formed from diamond material which can be diamond, polycrystalline diamond, Chemical Vapor Deposited Diamond, composite of polycrystalline diamond and CVD diamond, low surface roughness polycrystalline diamond, or other diamond substrate material. The graphene material film can be formed on the surface of the substrate by growing the graphene material layer on a second substrate and transferring and bonding the graphene material layer on the diamond material surface. The semiconductor material film is grown on the graphene material layer. The semiconductor material film is formed from one or more of AlN, AlGaN, GaN, AlInN, InGaN, AlInGaN, InAsP, InP, InGaAs, InAlAs, InGaSb, diamond, polycrystalline diamond, single-crystal diamond, chemical vapor deposited diamond, composite of chemically vapor deposited and polycrystalline diamond, highly oriented diamond, low surface roughness diamond, GaAs, silicon, GaSb, silicon, Germanium, AlP, ZnS, GaP, AlSb, AlAs, or combinations of semiconductor material layers or other materials known to those skilled in the art.

The semiconductor material film layer is typically deposited on the graphene material layer by MOCVD, plasma MOCVD, CVD, ALE, or MBE techniques or other techniques known to those skilled in the art. Because of the large thermal expansion coefficients mismatch between diamond material and the semiconductor material film, it is desirable that a low growth temperature be used. It is desirable that the growth method has low growth temperature capability.

Devices that can be formed in the semiconductor material film grown on a graphene material layer on a substrate include III-nitride High Electron Mobility Transistor (HEMT) device, lasers, high dynamic range photodiodes, and other devices known to those skilled in the art.

While the description for this embodiment is for the epitaxial growth of III-nitride semiconductor material film on a graphene material layer, similar process methods and device structures can be used for other semiconductor material films as is known to those skilled in the art. While the description for this embodiment is for a light emitting device, similar process methods and device structures can be used for other electronic devices, optoelectronic devices, photonic integrated circuit, micoelectromechnical, and photovoltaic devices as is known to those skilled in the art.

### Embodiment 6

### Photovoltaic Device on Graphene Material Layer Formed on a Glass Substrate

In this embodiment, the graphene material layer 703 can be first formed on the surface of a second substrate such as a metal foil substrate or SiC using processes known to those skilled in the art and then transferred to the substrate 705 using transfer and bonding processes known to those skilled in the art. Alternately, the graphene material layer 703 can be directly grown on a substrate using MBE, Microwave Enhanced CVD, hydrothermal or solvothermal growth approaches, metal-seed catalyzed reduction of a carbon source, or deposition of graphene flakes, deposition of graphene nanoplatelets, and other approaches for directly forming a graphene material layer on a surface known to those skilled in the art. In one embodiment, the substrate is a glass substrate. The glass substrate 405 can be a flexible substrate. The glass substrate 705 can be selected to be optically transparent to a high percentage of the sun light wavelengths. Normally, epitaxially growing single-crystal, or highly oriented, polycrystalline III-nitride layers directly onto a glass substrate is not possible; however, a graphene material layer on a glass substrate would provide an adequate crystal lattice at the surface of the graphene material layer to allow epitaxial growth of a semiconductor material film with sufficient material quality for a photovoltaic device. The graphene material layer also performs as a diffusion barrier layer so that contaminant in the substrate do not diffuse into the semiconductor material layer. The advantage of the use of a glass substrate is that the glass substrate enables larger size and lower cost photovoltaic devices and displays than can be obtained with a single-crystal substrates. The photovoltaic device can be topside illuminated or bottom side illuminated.

It is desirable that the semiconductor material film 701 growth process and anneal process be temperature compatible with the glass temperature capability. The process of forming graphene on a glass substrate requires a graphene formation temperature that is compatible with the temperature requirements of the glass substrate 705. Low temperature approaches of forming graphene on a substrate include growth on a second substrate and then transfer and bonding, growth of graphene on the surface of a metal layer on a glass substrate such growing graphene on nickel doped with gold catalyst, and plasma enhanced chemical vapor deposition, remote plasma enhanced chemical vapor deposition, or other methods known to those skilled in the art. The process of growing the semiconductor material film requires an epitaxial growth process that is compatible with the temperature requirements of the glass material. Molecular beam epitaxy, atomic layer epitaxy, and plasma MOCVD can grow III-nitride materials on glass substrate at a temperature compatible with the glass substrate. The semiconductor material film can also comprise organic semiconductor material, polymer semiconductor material, liquid crystal polymer material, crystalline polymer material, and quasi-crystalline polymer material. It is desirable that the thermal expansion coefficient of the glass substrate 705 material be selected to closely match the thermal expansion coefficient of the semiconductor material film 701.

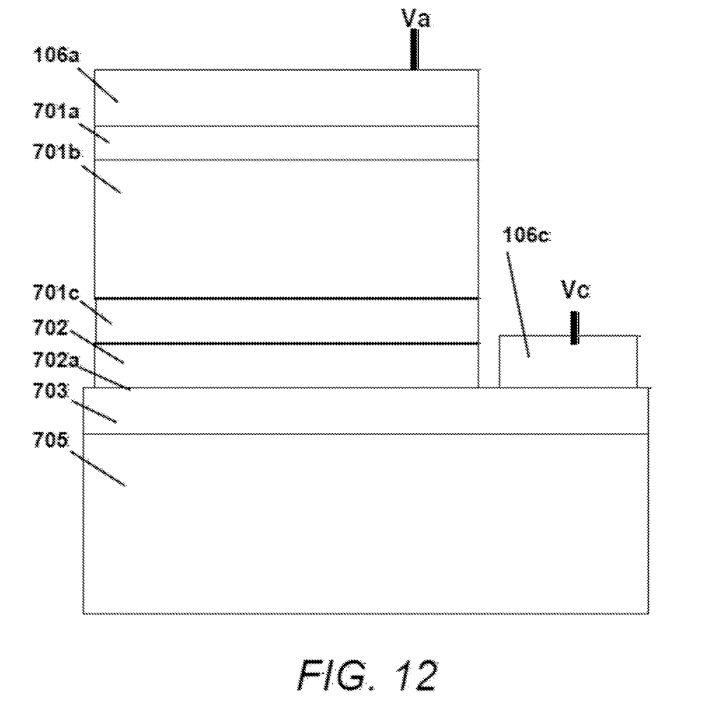

To facilitate electric contact to the transparent N-type Graphene Material Layer 703, an approach of using selective epitaxial semiconductor material film growth can be used. One approach to implement a selective growth approach is shown in FIG. 6. A silicon oxide layer is first deposited on the graphene surface, a lithography operation is performed to define regions where the silicon oxide will be etched, the silicon oxide is etched to the graphene material layer surface, the resist is stripped, the semiconductor material film 701a, 701b and 701c is grown, and then the oxide can be etched to the graphene material layer without substantially etching the graphene material layer to deposit a metal electrode contact on the surface of the graphene material layer. The semiconductor material film includes an N-type CdS layer 701c approximately 100 nm thick, a p-type CdTe layer 2 to 15 microns thick, and a P-type copper doped ZnTe contact semiconductor meeting 701a. An optional graphene interface transition layer 702 can be used to reduce the series resistance of the graphene material layer/semiconductor material film heterojunction. An optional graphene interface transition layer can also perform as an etch stop layer for etching the semiconductor material film and stopping the etch before etching to the graphene material layer 703. The transparent graphene material layer 703 is preferably doped N-type for low sheet resistance that will lower the forward voltage drop for the photovoltaic device at high forward currents. The preferred embodiment would have a low series resistance graphene material layer/semiconductor material film heterojunction 702a. An optional graphene interface transition layer can be used to lower the series resistance of the graphene material layer/semiconductor material heterojunction. One embodiment for a lower heterojunction series resistance is to use an optional graphene interface transition layer 702 material with an intermediate conduction band minimum potential level between the conduction band minimum potential levels of the semiconductor material film and the graphene material layer. Metal contact electrode 106a provides the anode voltage for this photovoltaic device. A second metal electrode 106c contact is made either to the transparent N-type graphene material layer 703 as shown in FIG. 12 or to the N-type CdS semiconductor material layer 701c. In operation, an optically generated forward bias is generated between electrodes 106a and 106c with current follow between the two electrodes in order to forward bias the photovoltaic pn diode. Holes are injected from the P-type CdTe region 701a into the N-type 701c and electrons are injected from the N-type CdS semiconductor material layer 701c. Current must cross the graphene material layer/semiconductor material layer heterojunction in the photovoltaic device in FIG. 12. A low series resistance graphene material layer/semiconductor material film heterojunction is preferred because the low series resistance heterojunction enable the low sheet resistance of the graphene material layer to parallel the sheet resistance of the N-type CdS layer and lower the total lateral resistance. The preferred embodiment would have low sheet resistance N-type doped graphene material layer and low resistance graphene material layer/semiconductor material film heterojunction for both the embodiment in FIG. 12.

An alternate approach of making a photovoltaic device is to subtractive etch the III-Nitride material to the N-type CdS layer 701c or graphene material layer 703. For the case that a subtractive etch of the III-Nitride material layer to the graphene material layer, a preferred approach is to have an etch-stop layer a one of the layers in the optional graphene interface transition layer 702 or in the semiconductor material layer

While the description for this embodiment is for the epitaxial growth CdTe, CdS, and ZnTe copper, similar process methods and device structures can be used for other photovoltaic device structures made with copper indium gallium selenide, copper zinc tin sulfide, copper zinc tin selenide, photovoltaic materials as is known to those skilled in the art. While the description for this embodiment is for a photovoltaic device, similar process methods and device structures can be used for other electronic devices, optoelectronic devices, photonic integrated circuit, micoelectromechnical, and photovoltaic devices as is known to those skilled in the art.

Aspects of specific exemplary embodiments of a structure in accordance with the present invention are illustrated in FIG. 12.

### Embodiment 7

### Photovoltaic Device on Graphene Material Layer Formed on a Metal Foil Substrate

This embodiment is similar to embodiment 6 for fabricating a photovoltaic device and to embodiment 4 for fabricating an light emitting device on a metal foil except that the graphene material layer 803 is fabricated by growing a graphene material layers on a metal foil substrate 805. The graphene material layer 803 can be formed on the surface of a catalytic or transition metal foil substrate such as copper, nickel, iron, stainless steel or other metal foil substrates using processes known to those skilled in the art. The metal foil substrate 805 can be a flexible substrate. The metal foil substrate 805 can be a composite substrate that can include the combination of a metal foil and an adhered polymer film. The adhered polymer film can provide additional mechanical strength and other properties known to those skilled in the art. The polymer film can be adhered after the graphene material growth process. The process of growing a graphene material layer 803 on the metal foil substrate in many embodiments require exposing the metal foil to a high growth temperature. The high growth temperature can make the foil even more flexible then a foil that has not be exposed to a high temperature anneal. The foil that has been exposed to a high temperature can have the characteristics of annealed metal foil. The metal foil substrate 805 surface can be prepared for selected or optimized growth of the graphene material layer 803. The metal foil substrate or the metal foil substrate surface can be anneal, polished, electropolished, chemically polished, electrodeposited, chemical mechanical polished, metal foil with low surface roughness, annealed, or annealed at a higher temperature than the graphene material growth temperature, or other selection or optimization process known to those skilled in the art. The graphene material layer growth temperature is often in the range of 750 C to 1050 C. Lower growth temperatures can be achieved by doping the surface of the nickel foil with gold or using a plasma process for decomposing the carbon containing molecules in the gas ambient. Higher temperature then 1050 C can be used to grow larger metal grains within the metal foil. The metal foil surface an be cleaned prior to the graphene material layer growth process to remove any unwanted oxides or physiabsorbed contaminants by washing in acetic acid or deioized water or other cleaning step known to those skilled in the art. Hydrogen containing gas can is can be used in the growth process for the graphene material layer on a metal as is known to those skilled in the art. The pressure for growth of the graphene material layer on metal foil substrate can be selected for preferred graphene material layer properties. For example, graphene material layer grown on copper in a vacuum is often a single graphene sheet while a graphene material layer grown at an atmospheric or high pressure is often a few graphene sheets thick. Normally epitaxially growing single-crystal, highly oriented, or polycrystalline semiconductor material layer with high material properties on semiconductor material film layers directly onto a metal foil substrate 805 is not possible; however, a graphene material layer 803 on a metal foil substrate would provide an adequate crystal lattice at the surface of the graphene material layer 803 to allow epitaxial growth of a semiconductor material film with sufficient material quality for a light-emitting device. The advantage of the use of a metal foil substrate is that the metal foil substrate enables larger size and lower cost light emitting devices. The photovoltaic device on a metal foil substrate is a top illuminated photovoltaic device.

It is desirable that the semiconductor material film 801a, 801b, growth process and anneal process be temperature compatible with the metal foil substrate 805 temperature capability. The process of forming graphene on a metal foil substrate requires a graphene formation temperature that is compatible with the temperature requirements of the metal foil substrate 805. Low temperature approaches of forming graphene on a metal layer include plasma enhanced chemical vapor deposition, or remote plasma enhanced chemical vapor deposition. The process of growing the semiconductor material film requires an epitaxial growth process that is compatible with the temperature requirements of the metal foil substrate material. Plasma MOCVD can grow CdS on metal foil substrate at a temperature compatible with the metal foil substrate material. It is desirable that the thermal expansion coefficient of the metal foil substrate 805 material be selected to closely match the thermal expansion coefficient of the semiconductor material film 801a or 801b. The remaining process steps for forming this embodiment are similar to those in embodiments 2 and 3 and 6.

While the description for this embodiment is for the epitaxial growth CdTe, CdS, and ZnTe copper, similar process methods and device structures can be used for other photovoltaic device structures made with copper indium gallium selenide, copper zinc tin sulfide, copper zinc tin selenide, photovoltaic materials as is known to those skilled in the art. While the description for this embodiment is for a photovoltaic device, similar process methods and device structures can be used for other electronic devices, optoelectronic devices, photonic integrated circuit, micoelectromechnical, and photovoltaic devices as is known to those skilled in the art.

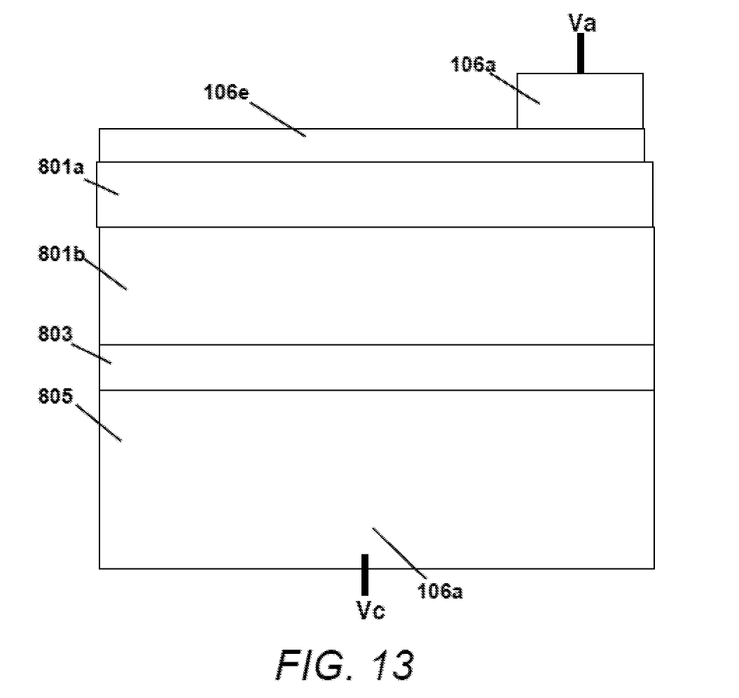

Aspects of specific exemplary embodiments of a structure in accordance with the present invention are illustrated in FIG. 13.

### Embodiment 7

### Semiconductor Material on Graphene Material Layer with Non-Flat Topography

In this embodiment, the graphene material layer 103t has non-flat topography. The non-flat topography can include ripple graphene topography, raised topography, substantially vertically oriented topography, substantially vertically aligned topography. The non-flat topography can be categorized by the degree of non-flatness. A first degree of non-flatness is a graphene material layer 103t is for the height of the of highest rise of graphene material layer t03 from a flat geometry is 20 nm. A second degree of non-flatness is a graphene material layer 103t is for the height of the of highest rise of graphene material layer 103t from a flat surface is 200 nm. A third degree of non-flatness is a graphene material layer 103t is for the height of the of highest rise of graphene material layer 103t from a flat surface is 500 nm. A fourth degree of non-flatness is a graphene material layer 103t is for the height of the of highest rise of graphene material layer 103t from a flat surface is 1000 nm. A fifth degree of non-flatness is a graphene material layer 103t is for the height of the of highest rise of graphene material layer 103t from a flat surface is 2000 nm. A sixth degree of non-flatness is a graphene material layer 103t is for the height of the of highest rise of graphene material layer 103t from a flat surface is 4000 nm. A seventh degree of non-flatness is a graphene material layer 103t is for the height of the of highest rise of graphene material layer 103t from a flat surface is 8000 nm. A eighth degree of non-flatness is a graphene material layer 103t is for the height of the of highest rise of graphene material layer 103t from a flat surface is 16000 nm. A ninth degree of non-flatness is a graphene material layer 103t is for the height of the of highest rise of graphene material layer 103t from a flat surface is 32000 nm.

The non-flat topography can be produced by depositing graphene flakes or graphene nanoplatelets on a surface. Techniques for depositing graphene flakes or graphene nanoplatelets on a surface include coating by spinning tool, coating by spraying tool, coating by dip approach, or other approaches known to those skilled in the art. The non-flat topography can also be formed by microwave plasma deposition and other technique known to those skilled in the art. One advantage of a non-flat topography is that there can be additional scattering and absorption of light and less reflection of light for a photovoltaic cell. The semiconductor material layer can be an one or more layers of inorganic semiconductor material film 101 or can be one or more layers of an organic material film such as PEDOT:PSS 101d.

The non flat topography can be first formed on the surface of a second substrate such as a metal foil substrate or SiC using processes known to those skilled in the art and then transferred to the substrate 705 using transfer and bonding processes known to those skilled in the art. Alternately, the graphene material layer 703 can be directly grown on a substrate using MBE, Microwave Enhanced CVD, hydrothermal or solvothermal growth approaches, metal-seed catalyzed reduction of a carbon source, or deposition of graphene flakes, deposition of graphene nanoplatelets, and other approaches for directly forming a graphene material layer on a surface known to those skilled in the art. In one embodiment, the substrate is a glass substrate. The glass substrate 405 can be a flexible substrate. The glass substrate 705 can be selected to be optically transparent to a high percentage of the sun light wavelengths. Normally, epitaxially growing single-crystal, or highly oriented, polycrystalline III-nitride layers directly onto a glass substrate is not possible; however, a graphene material layer on a glass substrate would provide an adequate crystal lattice at the surface of the graphene material layer to allow epitaxial growth of a semiconductor material film with sufficient material quality for a photovoltaic device. The graphene material layer also performs as a diffusion barrier layer so that contaminant in the substrate do not diffusion into the semiconductor material layer. The advantage of the use of a glass substrate is that the glass substrate enables larger size and lower cost photovoltaic devices and displays than can be obtained with a single-crystal substrates. The photovoltaic device can be topside illuminated or bottom side illuminated.

While the description for this embodiment is for the epitaxial growth CdTe, CdS, and ZnTe copper, similar process methods and device structures can be used for other photovoltaic device structures made with copper indium gallium selenide, copper zinc tin sulfide, copper zinc tin selenide, photovoltaic materials as is known to those skilled in the art. While the description for this embodiment is for a photovoltaic device, similar process methods and device structures can be used for other electronic devices, optoelectronic devices, photonic integrated circuit, micoelectromechnical, and photovoltaic devices as is known to those skilled in the art.

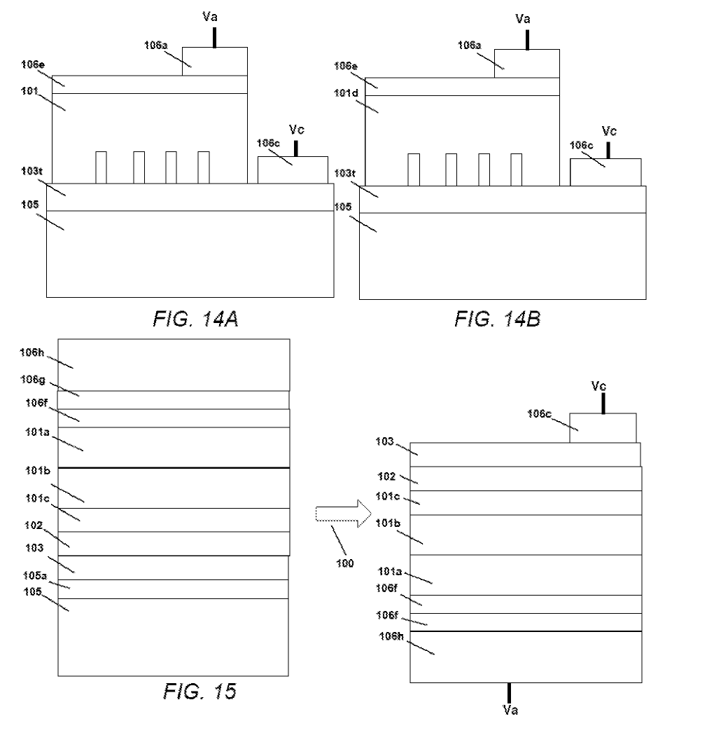

Aspects of specific exemplary embodiments of a structure in accordance with the present invention are illustrated in FIGS. 14A and 14B.

### Embodiment 8

### Attaching Semiconductor Material to Copper, Removing Substrate and Forming Light Emitting Device

This embodiment is similar to embodiment 1, 2, 3, 4, 5, 6, 7 except that the front surface of the semiconductor material film is attached to a copper heat sink/mount 106h, the substrate 105 removed, an optional metal layer 105a is removed and a contact electrode 106c is formed on the surface of the graphene material layer 103 by process 100. The graphene material layer 103 is a transparent electrode in this device. An etch stop can be implemented in the optional substrate transition layer 102 or the optional metal layer 105a can be used as an etch stop to facilitate removing the substrate without etching the graphene material layer 103. An Ohmic metal layer 106f is formed to the P-type semiconductor material layer 101a. A solder layer 106g is used to attach the semiconductor material/Ohmic metal to the copper heat sink/mount 106h.

While the description for this embodiment of attaching to a copper material is for a light emitting device, similar process methods and device structures can be used for other photovoltaic device, electronic devices, optoelectronic devices, photonic integrated circuit, micoelectromechnical, and photovoltaic devices as is known to those skilled in the art.

Aspects of specific exemplary embodiments of a structure in accordance with the present invention are illustrated in FIG. 15.

### Embodiment 9

### Removing the Substrate and Attaching to a Second Substrate

This embodiment is similar to embodiment 1, 2, 3, 4, 5, 6, 7, 8 except that the substrate is removed using process 100a by etching the substrate material or by undercutting the optional substrate transition layer 102 or the optional metal layer 105a by etching without etching the graphene material layer. Process 100A includes supporting the front side of the device structure with an polymer sheet with adhesive or a handle substrate and adhesive while the substrate is removed. After removal of the substrate 105 and the device structure is attached (bonded to a second substrate 105b. The second substrate 105b can be a flexible substrate such as a polymer substrate or a metal foil substrate.

While the description for this embodiment of transferring to a second substrate 105b is for a light emitting device, similar process methods and device structures can be used for photovoltaic device, electronic devices, optoelectronic devices, photonic integrated circuit, micoelectromechnical, and photovoltaic devices as is known to those skilled in the art.

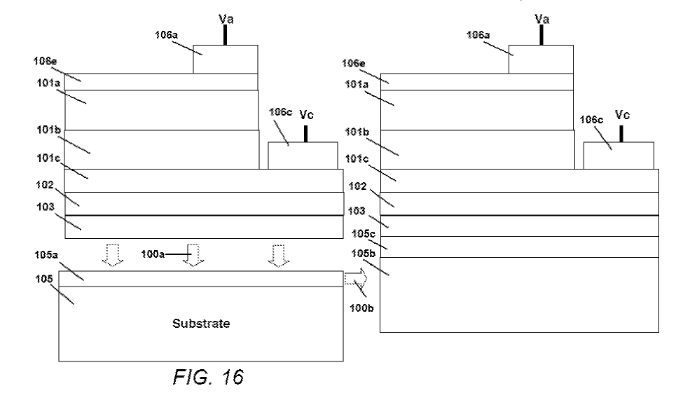

Aspects of specific exemplary embodiments of a structure in accordance with the present invention are illustrated in FIG. 16.

### Advantages and New Features:

One of the primary advantages of the use of graphene as a material layer in a device is that graphene has extremely high electric conductivity for extremely thin graphene material layer. A low graphene material layer sheet resistance is important to achieve a high frequency of operation for microwave device or a low forward drop for light emitting device. Many scientists believe that graphene has the potential to have the highest conductivity of any material and can have a higher conductivity of than silver for the same thickness. Experimental results indicate that the resistivity of a single sheet of graphene approximately 3 angstrom thick grown on the silicon face of SiC has a sheet resistance on the order of 750 ohm/square to 1000 ohms/square. Experimental results also indicate that a graphene sheet grown on the surface of copper can have a sheet resistance of approximately 1200 to 1500 ohms/square. The sheet resistance of graphene material having a few sheets of graphene can be less than 100 ohms/square. The thickness of a few sheets of graphene can be less than 1 nm. In addition, the high velocity of electrons in the graphene material can lower the graphene material layer transit time.

The use of graphene for graphene material layer of a structure can allow use of diamond as a substrate material that has very high thermal conductivity which will enable high power microwave devices while maintaining a device junction.

The enhanced lateral thermal conductivity of graphene can spread the thermal load to a larger area and thus reduce the thermal resistance.

Although particular embodiments, aspects, and features have been described and illustrated, one skilled in the art would readily appreciate that the invention described herein is not limited to only those embodiments, aspects, and features but also contemplates any and all modifications within the spirit and scope of the underlying invention described and claimed herein, and such combinations and embodiments are within the scope of the present disclosure.

The graphene material layer can be formed on the surface of the substrate by epitaxial growth of a graphene material layer on the substrate (such as a SiC substrate, metal film on a substrate, or metal foil substrate), by growth of a graphene material layer on a second substrate and then transfer and bonding of the graphene material layer to the substrate, by deposition of a graphene material layer, or by growth of a graphene material layer beneath a metal layer that is on a surface.

What is claimed is:

1. A structure comprising:
a graphene material layer comprising at least one sheet of graphene;
a semiconductor material film adjacent to a first side of the graphene material layer in at least one area of said graphene material layer and forming an semiconductor material film/graphene material layer interface therewith; and
a substrate adjacent to a second side of graphene material layer opposite the first side and forming a substrate/graphene material layer interface therewith.

2. The structure of claim 1, where the semiconductor material film comprises at least one semiconductor material.

3. The structure of claim 1, where the semiconductor material film comprises at least one semiconductor material and at least one insulator material.

4. The structure of claim 1, where the semiconductor material film comprises at least one organic semiconductor.

5. The structure of claim 1, where the semiconductor material film is formed in at least dielectric opening on the graphene material layer

6. The structure of claim 1, where the graphene material layer comprises one graphene sheet

7. The structure of claim 1, where the graphene material layer comprises two or more graphene sheets.

8. The structure of claim 1, where the graphene material layer comprises at least one of fluorinated, etched, doped, intercalalated, oxidized, and intentionally damaged graphene sheet.

9. A device comprising:
a graphene material layer comprising at least one sheet of graphene;
a semiconductor material film adjacent to a first side of the graphene material layer in at least one area of said graphene material layer and forming an semiconductor material film/graphene material layer interface therewith; and
a substrate adjacent to a second side of graphene material layer opposite the first side and forming a substrate/graphene material layer interface therewith.
a plurality of electrodes, each of the plurality of electrodes being connected to and forming a separate electrical connection to at least one of the semiconductor material film, the graphene material layer, and the substrate.

10. The device of claim 9, where electrode connection are made to the semiconductor material film, the graphene material layer and the substrate.

11. The device of claim 9, where the graphene material layer provides a conductive path for a device.

12. The device of claim 9, the electrode connections are made to the semiconductor material film and the graphene material layer.

13. The device of claim 9, where electrode connections are made to the semiconductor material film and the substrate.

14. The device of claim 9, where the device is a light emitting diode.

15. The device of claim 9, where the device is a photovoltaic device.

16. A method of forming a structure comprising:
forming a graphene material layer on a substrate comprising at least one sheet of graphene and forming a substrate/graphene material layer interface therewith; and
forming a semiconductor material film on a first side of the graphene material layer in at least one area of said graphene material layer and forming an semiconductor material film/graphene material layer interface therewith.

17. The method of claim 16, where the semiconductor film is formed by epitaxial growth.

18. The method of claim 16, where the semiconductor material film is formed by bonding

19. The method of claim 16, where the semiconductor material film is formed by depositing.

20. The method of claim 16, where the semiconductor material film is one of semiconductor material, insulator material, organic semiconductor material, and polymer semiconductor material
